(19) United States
(12) Patent Application Publication
(10) Pub. No.: US 2024/0179685 A1
(43) Pub. Date: May 30, 2024

(54) WI-FI SYSTEM AND ASSOCIATED CHANNEL ALLOCATION METHOD

(71) Applicant: MEDIATEK Inc., Hsinchu City (TW)

(72) Inventor: Ming-Wang GUO, Hsinchu City (TW)

(21) Appl. No.: 18/515,577

(22) Filed: Nov. 21, 2023

Related U.S. Application Data
(60) Provisional application No. 63/385,218, filed on Nov. 29, 2022.

(51) Int. Cl. H04W 72/02; H04L 5/00; H04W 72/51

(52) U.S. Cl. CPC H04W 72/02; H04L 5/0057; H04W 72/51; H04W 84/12

(57) ABSTRACT

A Wi-Fi system and an associated channel allocation method are provided. The Wi-Fi system includes an access point (AP) device and a station (STA) device. The AP device collects AP-side capability information, and the STA device collects STA-side capability information. The STA device transmits STA-side capability information to the AP device. The AP device analyzes the AP-side capability information and the STA-side capability information to select an optimized channel accordingly. Later, the AP device and the STA device perform frame exchange procedures on the optimized channel. The throughput of the Wi-Fi system is improved because the selection of the optimized channel reduces potential conflicts.

This application claims the benefit of U.S. provisional application Ser. No. 63/385,218, filed Nov. 29, 2022, the disclosure of which is incorporated by reference herein in its entirety.

### TECHNICAL FIELD

The disclosure relates in general to a Wi-Fi system and an associated channel allocation method, and more particularly to a Wi-Fi system and an associated channel allocation method capable of switching working channels based on collecting channel capability information from different Wi-Fi devices.

### BACKGROUND

As Wi-Fi products become more and more popular, it happens from time to time that the Wi-Fi environment is dense. Thus, a user often suffers from poor network performance caused by interferences between the neighboring access point (AP) devices and station (STA) devices.

The association relationship between an AP device and an STA device includes three parts: a scanning mode (scanMD), a connection establishment mode (estMD), and a connected mode (conMD). In the scanning mode (scanMD), the AP device scans candidate Wi-Fi channels in the medium environment and selects a default channel defCH. In the connection establishment mode (estMD), the AP device and the STA device exchange their association-related information on the default channel defCH. The AP and the STA devices become connected after the connection establishment mode (estMD) is complete. Then, the default channel defCH is utilized as the working channel wrkCH in the connected mode (conMD), and the AP device and the STA device perform frame exchange procedures on the working channel wrkCH.

Conventional AP devices provide an automatic channel allocation function in the scanning mode (scanMD) to maximize the network performance in a dense Wi-Fi environment. The conventional channel allocation function involves an AP device attempting to identify a free channel among available channels. In the connection establishment mode (estMD), the AP device then informs the STA device to jump to the free channel (as the working channel wrkCH) to avoid interference. However, the selection of the working channel wrkCH is made unilaterally, and the working channel wrkCH might be affected in the connected mode (conMD). That is, the conventional AP device considers only the channel capability information collected by itself.

The disadvantage of unilateral decision-based channel allocation is illustrated in FIGS. 1A˜1C. FIGS. 1A˜1C (prior art) are schematic diagrams illustrating that the conventional channel allocation method might cause conflict. In FIGS. 1A˜1C, status changes of a Wi-Fi system including two AP devices (APa, APb) are described in chronological order.

The dotted circles on the left side of FIGS. 1A˜1C represent the coverage area of a basic service set BSSa 10a and the dotted circles on the right side of FIGS. 1A˜1C represent the coverage area of a basic service set BSSb 10b. The basic service set (BSSa) 10a corresponds to an access point (APa) device 11a, and the basic service set (BSSb) 10b corresponds to an access point (APb) device 11b. In the specification, the lowercase letters “ch” represent the Wi-Fi channel number defined by the Wi-Fi standards.

FIG. 1A shows a Wi-Fi environment in which the APa device 11a is in the scanning mode (scanMD). In FIG. 1A, the APa device 11a is not yet associated with any STA device, and it is assumed that the APa device 11a selects Wi-Fi channel ch6 as its default channel defCH(a) after scanning the candidate Wi-Fi channels. That is, defCH(a)=ch6. On the other hand, the APb device 11b and the STA1 device 13a are in the connected mode (conMD), and the working channel wrkCH(b) corresponding to the BSSb 10b is Wi-Fi channel ch6. That is, wrkCH(b)=ch6. In the following, the association relationship between the APa device 11a and STA2 device 13b is concerned. The association relationship between the APb device 11b and the STA1 device 13a is assumed to be unchanged and not particularly described.

Based on the conventional channel allocation method, the APa device 11a knows that Wi-Fi channel ch6 is not in use within the coverage area of the BSSa 10a. Thus, the APa device 11a allocates Wi-Fi channel ch6 as the default channel defCH(a)=ch6 in the BSSa 10a in FIGS. 1A and 1B.

FIG. 1B shows that an STA2 device 13b physically enters the Wi-Fi environment, and the STA2 device 13b is located at an overlapped area of the coverage area of the BSSa 10a and BSSb 10b. In FIG. 1B, the STA2 device 13b and the APa device 11a are in the connection establishment mode (estMD). In the connection establishment mode (estMD), the APa device 11a and the STA2 device 13b utilize the default channel defCH(a)=ch6 to exchange their association-related information.

FIG. 1C demonstrates that the APa device 13a continuously utilizes the default channel defCH(a)=ch6 in the connection establishment mode (estMD) as the working channel wrkCH(a)=ch6 in the connected mode (conMD). In other words, the STA2 device 13b and the APa device 11a continue to perform the frame exchange procedures on Wi-Fi channel ch6 as well.

As shown in FIG. 1C, two sets of frame exchange procedures are performed on Wi-Fi channel ch6 in the meantime. One set of frame exchange procedures is performed between the APb device 11b and the STA1 device 13a, and the other one is performed between the APa device 11a and the STA2 device 13b. Consequentially, conflict will highly likely occur on Wi-Fi channel ch6.

According to the conventional channel allocation approach, the APa device 11a dominates the selection of working channel wrkCH(a). However, a conventional AP device does not know the surrounding medium environment in a comprehensive view. Such a centralized decision considers limited information and results in potential conflicts.

### SUMMARY

The disclosure is directed to a Wi-Fi system and an associated channel allocation method capable of selecting the appropriate Wi-Fi channel as the working channel. The working channel is determined based on various channel capability information jointly collected by different Wi-Fi devices. The throughput of the Wi-Fi system can be improved as the potential conflict is reduced based on comprehensive analyses performed by the AP device.

According to one embodiment, a Wi-Fi system is provided. The Wi-Fi includes a first Wi-Fi device and a second Wi-Fi device. The first Wi-Fi device collects first channel capability information corresponding to the first Wi-Fi device. The second Wi-Fi device collects and transmits second channel capability information corresponding to the second Wi-Fi device to the first Wi-Fi device. The first Wi-Fi device analyzes the first channel capability information and the second channel capability information in a connected mode to select an optimized channel accordingly.

According to another embodiment, a channel allocation method applied to the Wi-Fi system is provided. The Wi-Fi system includes a first Wi-Fi device and a second Wi-Fi device. The channel allocation method includes the following steps. The first Wi-Fi device collects first channel capability information corresponding to the first Wi-Fi device. The second Wi-Fi device collects and transmits second channel capability information corresponding to the second Wi-Fi device to the first Wi-Fi device. The first Wi-Fi device analyzes the first channel capability information and the second channel capability information in a connected mode to select an optimized channel accordingly.

### BRIEF DESCRIPTION OF THE DRAWINGS

FIGS. 1A˜1C (prior art) are schematic diagrams illustrating that the conventional channel allocation method might cause conflict.

FIG. 2A is a schematic diagram illustrating an exemplary data format of the frame body of a capability reporting frame (capRpFrm).

FIG. 2B is a schematic diagram illustrating an exemplary capability reporting frame (capRpFrm) that provides channel capability information corresponding to M=5 quality factors in N=3 candidate Wi-Fi channels.

FIG. 3 is a schematic diagram illustrating a Wi-Fi device supporting

the channel allocation method according to the embodiment of the present disclosure.

FIGS. 4A˜4E are schematic diagrams illustrating that the default channel defCH(a)=ch6, selected by the APa device in the connection establishment mode (estMD), is directly utilized as the current working channel wrkCH(a)=ch6, and Wi-Fi channel ch6 is continuously used in the connected mode (conMD) because the current working channel wrkCH(a)=ch6 is consistent with the optimized BSS channel obCH(APa+STA2)=ch6, as determined by the APa device based on the STA-side channel capability information CHinfo(STA2) and the AP-side channel capability information CHinfo(APa).

FIGS. 5A˜5E are schematic diagrams illustrating that, although the default channel defCH(a)=ch6, previously selected by the APa device in the connection establishment mode (estMD), is directly utilized as the current working channel wrkCH(a)=ch6, Wi-Fi channel ch6 is no longer used in the connected mode (conMD) because the current working channel wrkCH(a)=ch6 is different from the optimized BSS channel obCH(APa+STA2)=ch11, as determined by the APa device based on the STA-side channel capability information CHinfo(STA2) and the AP-side channel capability information CHinfo(APa).

FIGS. 6A and 6B are schematic diagrams illustrating the association relationship between the APa device and the STA2 device regarding how the working channel wrkCH(a) is determined by referring to the STA-side channel capability information CHinfo(STA2) collected in the connection establishment mode (estMD).

FIGS. 7A˜7C is a flow diagram illustrating the operations and interactions between the APa device and the STA2 device regarding how the working channel wrkCH(a) is determined by referring to the STA-side channel capability information CHinfo(STA2) collected in the connection establishment mode (estMD).

FIGS. 8A˜8C are schematic diagrams illustrating that Wi-Fi channel ch11 is continuously used in the connected mode (conMD) because the current working channel wrkCH(a)=ch11 is consistent with the optimized BSS channel obCH(APa+STA2)=ch11, which is determined by the APa device based on the STA-side channel capability information CHinfo(STA2) and the AP-side channel capability information CHinfo(APa) collected in the connected mode (conMD).

FIGS. 9A˜9C are schematic diagrams illustrating that, instead of continuously using Wi-Fi channel ch11 in the connected mode (conMD), Wi-Fi channel ch6 is used because the current working channel wrkCH(a)=ch11 is different from the optimized BSS channel obCH(APa+STA2)=ch6, which is determined by the APa device based on the STA-side channel capability information CHinfo(STA2) and the AP-side channel capability information CHinfo(APa) collected in the connected mode (conMD).

FIGS. 10A and 10B are a schematic diagram illustrating how the APa device determines whether the current working channel wrkCH(a) should be switched based on the comparison between the current working channel wrkCH(a) and the optimized BSS channel obCH(APa+STA2), wherein the optimized BSS channel obCH(APa+STA2) is determined by referring to the STA-side channel capability information CHinfo(STA2) collected in the connected mode (conMD).

FIGS. 11A and 11B are a flow diagram illustrating how the APa device determines whether the current working channel wrkCH(a) should be switched based on the comparison between the current working channel wrkCH(a) and the optimized BSS channel obCH(APa+STA2), wherein the optimized BSS channel obCH(APa+STA2) is determined by referring to the STA-side channel capability information CHinfo(STA2) collected in the connected mode (conMD).

FIGS. 12A˜12E are schematic diagrams illustrating a scenario in which the updated working channel wrkCH(a)′ corresponding to the BSSa is selected based on the AP-side channel capability information CHinfo(APa), the STA-side channel capability information CHinfo(STA2) collected from the STA2 device operating in the connected mode (conMD), and the STA-side channel capability information CHinfo(STA3) collected from the STA3 device operating in the connection establishment mode (estMD).

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

A channel allocation method based on considering channel quality from multiple sources is described below. According to the embodiment of the present disclosure, a mechanism is designed to let the STA device report its STA-side channel capability information CHinfo(STA) to the AP device. Then, the AP device can select the appropriate working channel wrkCH based on the STA-side channel capability information CHinfo(STA) reported by its associated STA devices and its own AP-side channel capability information CHinfo(AP).

In comparison with the conventional approaches, the AP device determines the working channel wrkCH based on the channel capability information collected from different sources, including those from STA device(s) CHinfo(STA) and the one collected by the AP device itself. For the sake of illustration, a frame used to carry the STA-side channel capability information CHinfo(STA) is defined as a capability reporting frame (capRpFrm) 25. The capability reporting frame (capRpFrm) 25 can be integrated into different types of frames defined in Wi-Fi standards.

The capability reporting frame (capRpFrm) 25 can be considered as a data carrier providing the STA-side channel capability information CHinfo(STA), and the data format of the capability reporting frame (capRpFrm) 25 can be flexibly designed. An exemplary frame body of a capability reporting frame (capRpFrm) 25 is illustrated below. The physical layer (PHY) header and the medium access control (MAC) header are not illustrated in the specification.

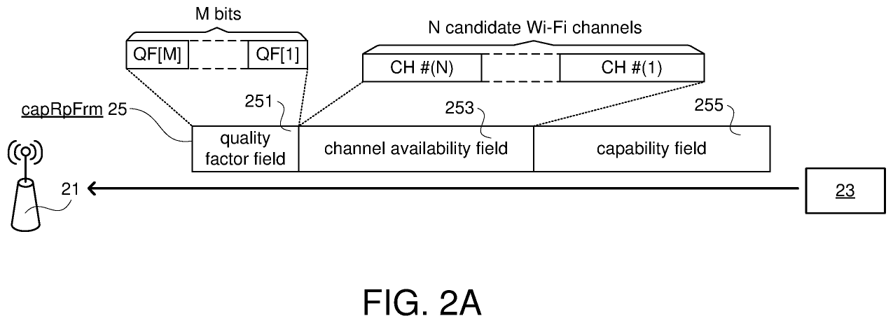

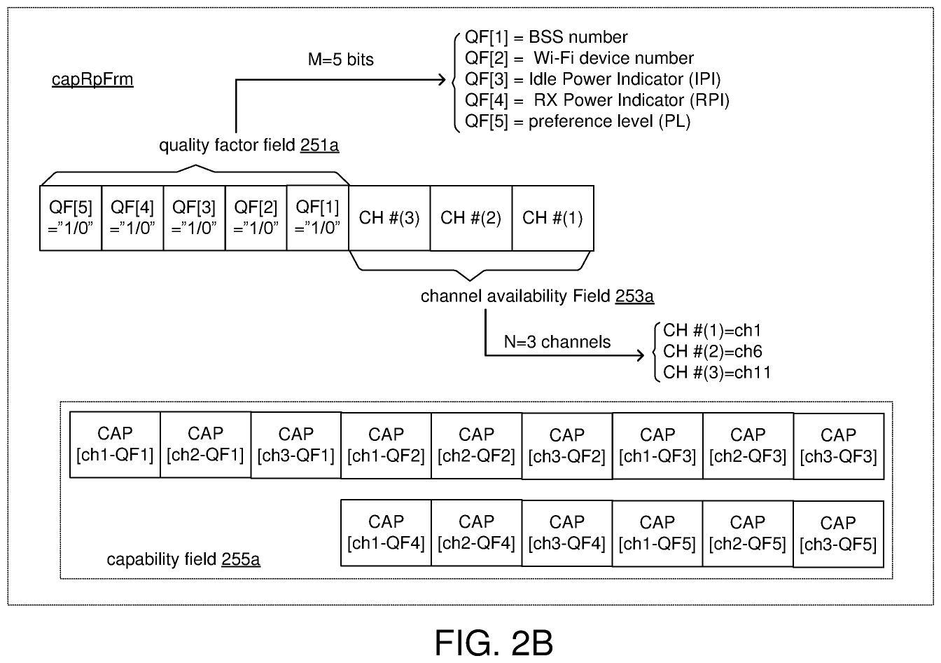

FIG. 2A is a schematic diagram illustrating an exemplary data format of the frame body of a capability reporting frame. The capability reporting frame (capRpFrm) 25 includes a quality factor field 251, a channel availability field 253, and a capability field 255. The quality factor field 251 represents M quality factors in a bitwise format. The channel availability field 253 represents N candidate Wi-Fi channels (CH #(1)˜CH #(N)) that the STA device 23 and the AP device 21 could communicate with. In practical applications, the candidate Wi-Fi channels may be located at any of the 2.4 GHz, 5 GHz, and 6 GHz bands, as defined by the Wi-Fi standards. The capability field 255 represents the STA-side channel capability information CHinfo(STA) corresponding to the M quality factors and the N candidate Wi-Fi channels.

The quality factor field 251 includes M bits, respectively representing whether the M quality factors QF[1]˜QF[M] are set as enabled. The number (M) and types of quality factors are not limited. For example, the quality factors may include at least one of the following parameters: BSS number, channel idle ratio, channel idle/busy time, clear channel assessment (CCA). transmission/receiving status, device number per channel, overlapping basic service set (OBSS) numbers, and so forth.

The M quality factors QF[1]˜QF[M] represent the parameters referred by the AP device 21 to select/allocate the working channel wrkCH. The STA device respectively checks different channel qualities corresponding to the N candidate Wi-Fi channels (CH #(1)˜CH #(N)) to generate the STA-side channel capability information CHinfo(STA). These channel qualities are transformed and represented as the M quality factors QF[1]˜QF[M].

FIG. 2B is a schematic diagram illustrating an exemplary capability reporting frame that provides the channel capability information corresponding to M=5 quality factors in N=3 candidate Wi-Fi channels. An exemplary set of quality factors represented by the bitwise quality indicators BIT(5)˜BIT(1) are demonstrated in FIG. 2B and summarized in Table 1.

TABLE 1

| | bitwise quality indicator | | | | |
|---|---|---|---|---|---|
| | BIT(5) | BIT(4) | BIT(3) | BIT(2) | BIT(1) |
| quality | QF[5] | QF[4] | QF[3] | QF[2] | QF[1] |
| factor | | | | | |
| type of | preference | receiving | idle power | Wi-Fi | BSS |
| quality | level (PL) | (RX) | indicator | number | number |
| factor | | power | (IPI) | | |
| | | indicator | | | |
| | | (RPI) | | | |

The bitwise quality indicator BIT(1) corresponds to a quality factor QF[1] representing the requested BSS number of a corresponding channel. When the quality factor QF[1] is set to “1” (QF[1]=1), the STA device reports the requested BSS numbers of the supported channels. When the quality factor QF[1] is set to “0” (QF[1]=1), the STA device does not report the requested BSS numbers of the candidate Wi-Fi channels.

The bitwise quality indicator BIT(2) corresponds to a quality factor QF[2] representing the requested Wi-Fi device number of a candidate Wi-Fi channel (CH #(n)). The bitwise quality indicator BIT(3) corresponds to a quality factor QF[3], representing the requested idle power indicator (IPI) of a candidate Wi-Fi channel (CH #(n)). The bitwise quality indicator BIT(4) corresponds to a quality factor QF[4], representing the requested receiving (RX) power indicator (RPI) of a candidate Wi-Fi channel (CH #(n)). The bitwise quality indicator BIT(5) corresponds to a quality factor QF[5] representing the requested preference level (PL) of a candidate Wi-Fi channel (CH #(n)). The variable “n” and “N” are positive integers, N≥2, and n≤N. As the setting mechanisms of quality factors QF[2]˜QF[5] are similar to those of the quality factor QF[1], details of which are omitted.

In practical applications, the STA device 23 might not be able to provide all the M quality factors QF[1]˜QF[M] as predefined by the AP device 21. It can be assumed that an STA device 23 can provide P quality factors. P and M are positive integers, and P≤M.

For example, if the STA device 23 provides only the quality factor QF[1] representing the requested BSS number of a candidate Wi-Fi channel (CH #(n)) and the quality factor QF[5] representing the requested preference level (PL) of a candidate Wi-Fi channel (CH #(n)), P=2<M=5, and the STA device 23 sets the quality factor field 251 to “10001”. For another example, if STA device 23 provides all the quality factors QF[1]˜QF[5] in Table 1, P is equivalent to M (P=M=5), and STA device 23 sets the quality factor field 251 to “11111”.

The channel availability field 253 includes N portions, and the N portions respectively represent the N candidate Wi-Fi channels that the STA device 23 could connect with the AP device 21 based on the active/passive scanning result. Thus, the bit length of each N portion is related to N. The more channels are available for the STA device 23, the greater the value N is and the longer the bit length of each N portion. The data format of the frame content is not limited to the embodiments.

The value of N is varied with different medium environments and STA device 23. Thus, two STA devices may belong to the same BSS but correspond to different N values. For the sake of clarification, the lowercase letters “ch” represent the Wi-Fi channel number defined by the Wi-Fi standards, and the capital letters “CH” represent Wi-Fi channels accessible for a Wi-Fi device (that is, candidate Wi-Fi channels). Assuming N=3, Table 2 is an exemplary combination of the channel availability field 253.

TABLE 2

candidate Wi-Fi channel

| | CH #(1) | CH #(2) | CH #(3) |
|---|---|---|---|
| Wi-Fi channel | ch1 | ch6 | ch11 |
| number, (wherein | | | |
| BIT(2) is set as | | | |
| enabled) | | | |

In practical applications, the numbering represented in the first row of Table 2 does not need to be consistent with the channel order or channel number defined in the Wi-Fi standards. For example, the candidate Wi-Fi channel CH #(1) might correspond to Wi-Fi channel ch11, the candidate Wi-Fi channel CH #(2) might correspond to Wi-Fi channel ch1, and the candidate Wi-Fi channel CH #(3) might correspond to Wi-Fi channel ch6.

The capability field 255 represents the STA-side channel capability information CHinfo(STA) corresponding to the M quality factors and the N candidate Wi-Fi channels. Therefore, the data size of the capability field 255 is changed with the value of M and/or P.

In the case that the STA device 23 sets the quality factor field 251 of the capability reporting frame (capRpFrm) 25 to “10001” and the channel scan result of the STA device 23 shows that the 3 channels in Table 2 are supported, the capability field 255 is like Table 3.

TABLE 3

| | | candidate Wi-Fi channel | | |
|---|---|---|---|---|
| | | CH #(1) | CH #(2) | CH #(3) |
| quality | BIT(1) = 1 | BSS number | BSS number of | BSS number of |
| factor | | of CH #(1) | CH #(2) | CH #(3) |
| | BIT(2) = 0 | NA | NA | NA |
| | BIT(3) = 0 | NA | NA | NA |
| | BIT(4) = 0 | NA | NA | NA |
| | BIT(5) = 1 | PL of CH #(1) | PL of CH #(2) | PL of CH #(3) |

In the case that the STA device 23 sets the quality factor field 251 of the capability reporting frame (capRpFrm) 25 to “11111” and the channel scan result of the STA device 23 shows that the 3 channels in Table 2 are supported, the capability field 255 is like Table 4.

TABLE 4

| | candidate Wi-Fi channel | | |
|---|---|---|---|
| | CH #(1) | CH #(2) | CH #(3) |
| BIT(1) = 1 | BSS number | BSS number | BSS number |
| | of CH #(1) | of CH #(2) | of CH #(3) |
| BIT(2) = 1 | Wi-Fi channel | Wi-Fi channel | Wi-Fi channel |
| | number of | number of | number of |
| | CH #(1) | CH #(2) | CH #(3) |
| BIT(3) = 1 | IPI of CH #(1) | IPI of CH #(2) | IPI of CH #(3) |
| BIT(4) = 1 | RPI of CH #(1) | RPI of CH #(2) | RPI of CH #(3) |
| BIT(5) = 1 | PL of CH #(1) | PL of CH #(2) | PL of CH #(3) |

In practical applications, the capability field 255 listed in Tables 3 and 4 can be arranged in a row-by-row order or a column-by-column order (per channel). The data layout of the quality factor field 251, the channel availability field 253, and the capability field 255 are not limited once the AP device 21 and the STA device 23 have reached an agreement in advance.

According to the embodiment of the present disclosure, STA device 23 constructs capability reporting frame (capRpFrm) 25 and transmits capability reporting frame (capRpFrm) 25 to AP device 21. After AP device 21 receives the capability reporting frame (capRpFrm) 25, AP device 21 parses the content of capability reporting frame (capRpFrm) 25 to acquire the STA-side channel capability information CHinfo(STA). Later, when AP device 21 selects the most appropriate one among the candidate Wi-Fi channels, AP device 21 refers to the AP-side channel capability information collected from itself (that is, CHinfo(AP)) and the STA-side channel capability information received from its associated STA device(s) (that is, CHinfo(STA)). In the specification, the Wi-Fi channel selected by AP device 21 in the multilateral quality factor analyses is defined as an optimized BSS channel (obCH(AP+STA)).

To support the format flexibility of the capability reporting frame (capRpFrm) 25, the channel allocation method can be implemented with driver and/or firmware. On the other hand, it is possible to implement the parsing and the frame construction function with hardware to accelerate the speed. The hardware/software implementation of the channel allocation method is not limited.

As the data format of the capability reporting frame (capRpFrm) 25 is not rigid, the constructions and definitions of the capability reporting frame (capRpFrm) 25 are flexible. Some alternative designs are mentioned below. However, the design of the capability reporting frame (capRpFrm) 25 is not limited to the embodiments.

For example, the quality factor field 251 can be omitted if STA device 23 and AP device 21 agree to use only default/predefined types of quality factors in advance. In such case, the data size of the capability field 255 is fixed, and the STA device 23 needs to fill in “0” or a default value to represent that some of the capability fields 255 are “invalid”. Although the flexibility might be slightly affected and the size of the capability field 255 might be increased, such data layout is more suitable for hardware implementation as the parsing operations of the AP device 21 can be accelerated, and data corresponding to the unused field can be directly dropped by the hardware circuit.

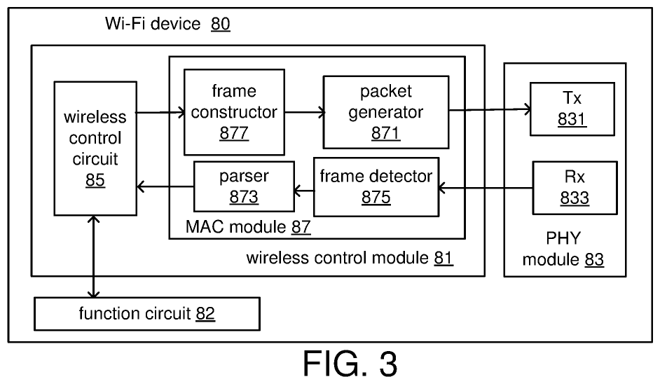

FIG. 3 is a schematic diagram illustrating a Wi-Fi device supporting the channel allocation method according to the embodiment of the present disclosure. The Wi-Fi device 80 can represent the AP device 21 or the STA device 23. To adopt the use of capability reporting frame (capRpFrm) 25, AP device 21 needs to modify its parsing function, and STA device 23 needs to modify its frame construction function.

According to the embodiment of the present disclosure, the Wi-Fi device 80 includes a function circuit 82, a wireless control module 81, and a PHY module 83. The function circuit 82 cooperates with the wireless control module 81 to have a Wi-Fi access function. The wireless control module 81 is electrically connected to the function circuit 82 and the PHY module 83.

The wireless control module 81 includes a wireless control circuit 85 and a medium access control (MAC) module 87. The MAC module 87 further includes a transmission path (including a frame constructor 877 and a packet generator 871) and a receiving path (including a frame detector 875 and a parser 873).

The frame constructor 877 is electrically connected to the wireless control circuit 85 and the packet generator 871. In the case that the Wi-Fi device 80 is the STA device 23, the wireless control circuit 85 provides the STA-side channel capability information CHinfo(STA) to the frame constructor 877. Then, the frame constructor 877 constructs the content of the capability reporting frame (capRpFrm) 25 based on the STA-side channel capability information CHinfo(STA), and the packet generator 873 inserts the MAC header into the capability reporting frame (capRpFrm) 25 to form MAC packets.

The parser 873 is electrically connected to the wireless control circuit 85 and the frame detector 875. In the case that the Wi-Fi device 80 is the AP device 21, the frame detector 875 acquires the capability reporting frame (capRpFrm) 25 from the incoming MAC layer packet, and the parser 873 parses the contents of the capability reporting frame (capRpFrm) 25, based on the fields mentioned in FIG. 2. Then, the parsed STA-side channel capability information CHinfo(STA) is transmitted to the wireless control circuit 85 for comprehensive multilateral quality factor analyses.

The PHY module 83 includes a transmitter 831 and a receiver 833. The transmitter 831 receives the outgoing MAC layer packets from the packet generator 871 and generates outgoing PHY packets accordingly. The receiver 833 receives incoming PHY packets and transmits incoming MAC layer packets to the frame detector 875.

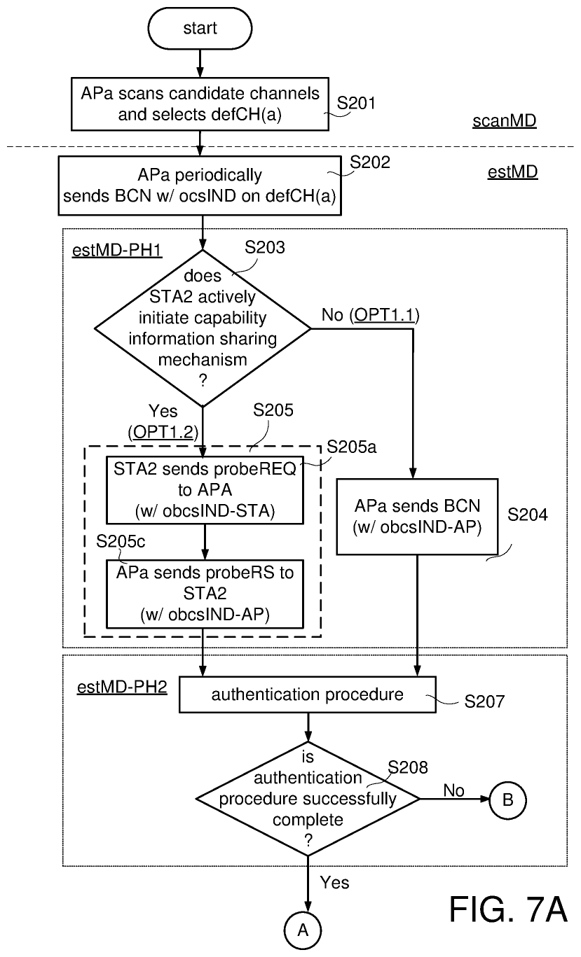

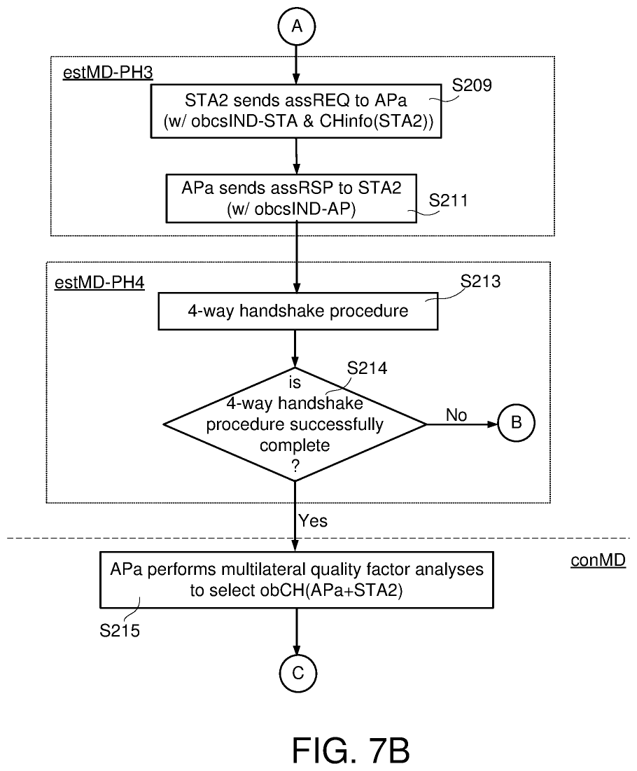

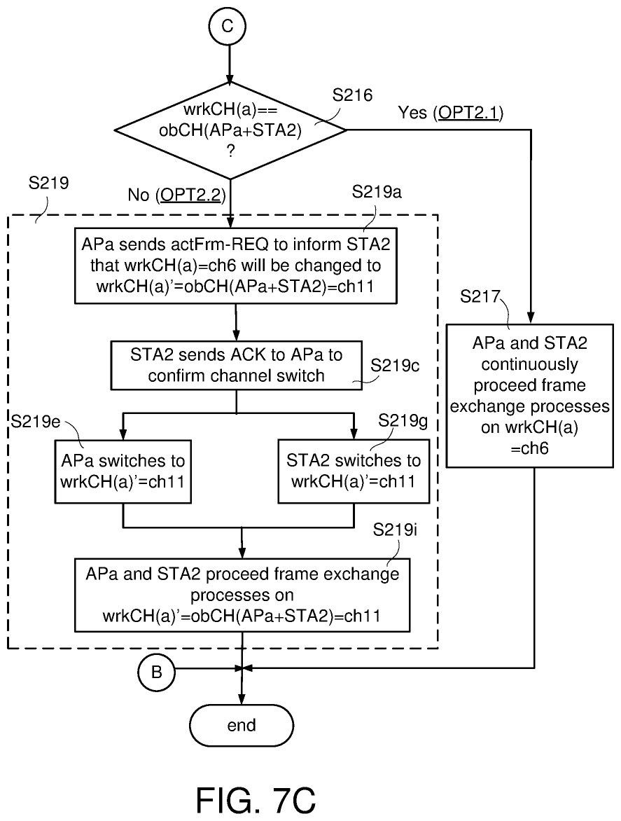

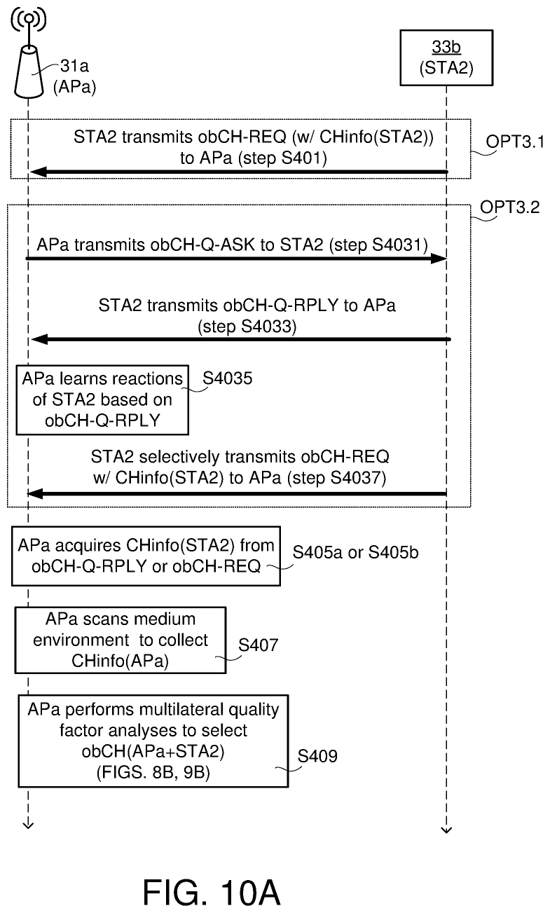

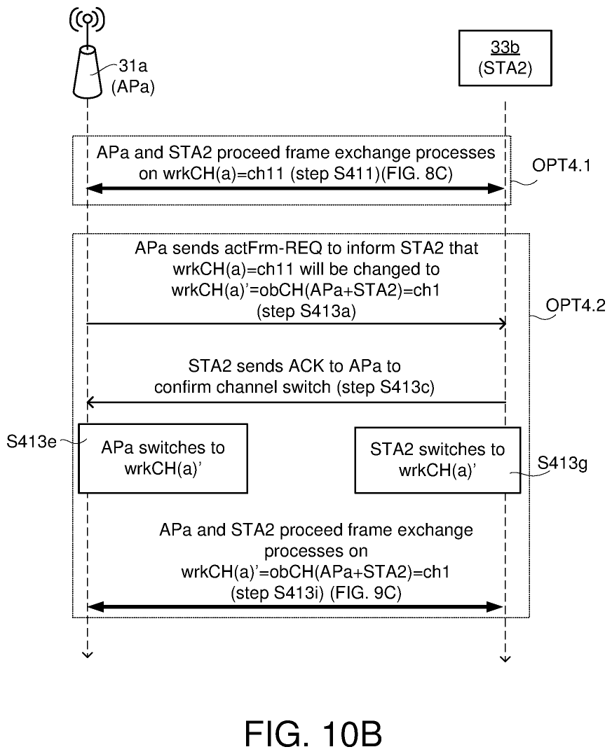

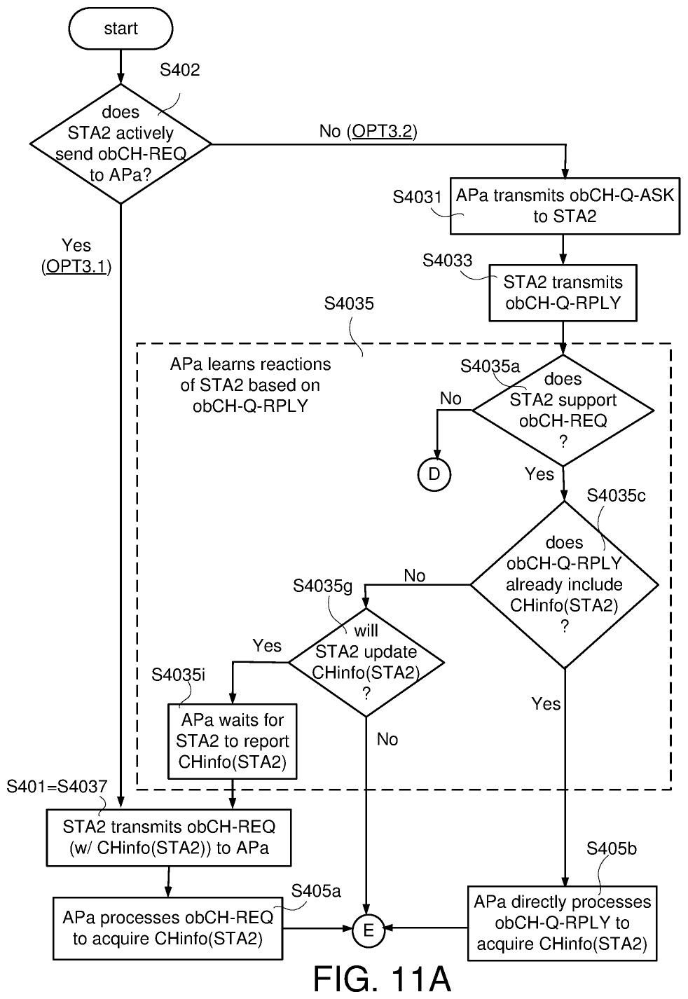

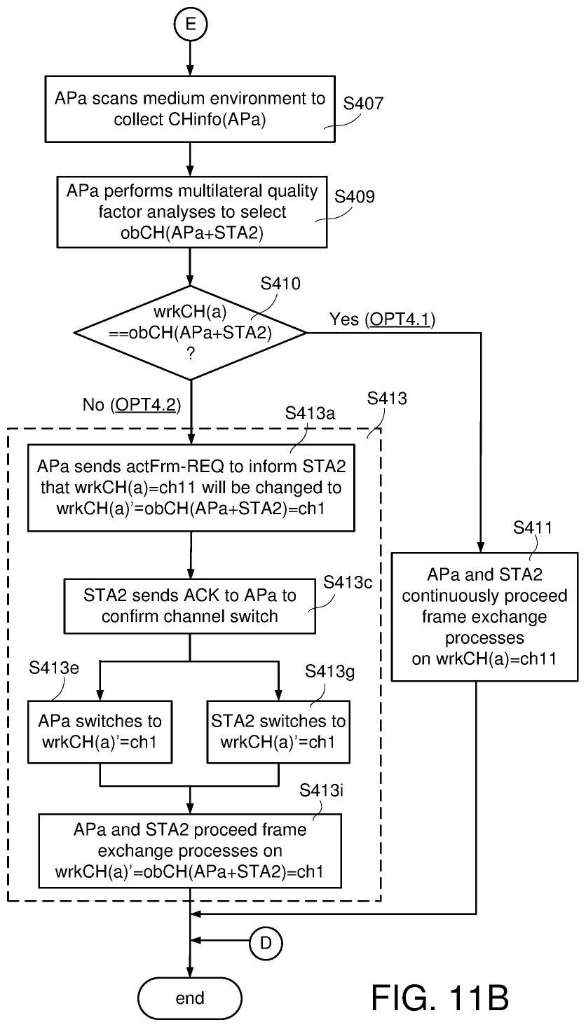

Please note that the capability reporting frame (capRpFrm) is a generic term to demonstrate how the STA-side channel capability information CHinfo(STA) can be carried. According to the embodiment of the present disclosure, the protocols between the AP device 21 and the STA device 23 can be modified to pass the capability reporting frame (capRpFrm) from the STA device 23 to the AP device 21. Depending on the modified protocols between the AP device 21 and the STA device 23, the capability reporting frame (capRpFrm) may be integrated in different types of frames, for example, an association request (assREQ) frame (see step S209 in FIGS. 6A and 7B), an optimized BSS channel request (obCH-REQ) frame (see steps 401, S4037 in FIGS. 10A and 11A), a query-reply frame of the optimized BSS channel (obCH-Q-RPLY) (see step S4033 in FIGS. 10A and 11A), and so forth.

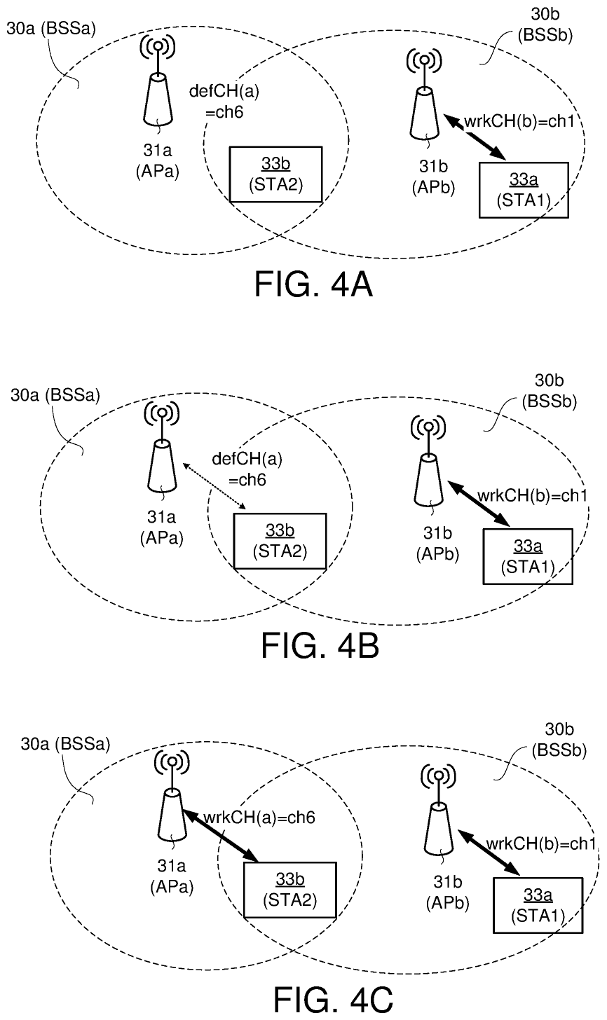

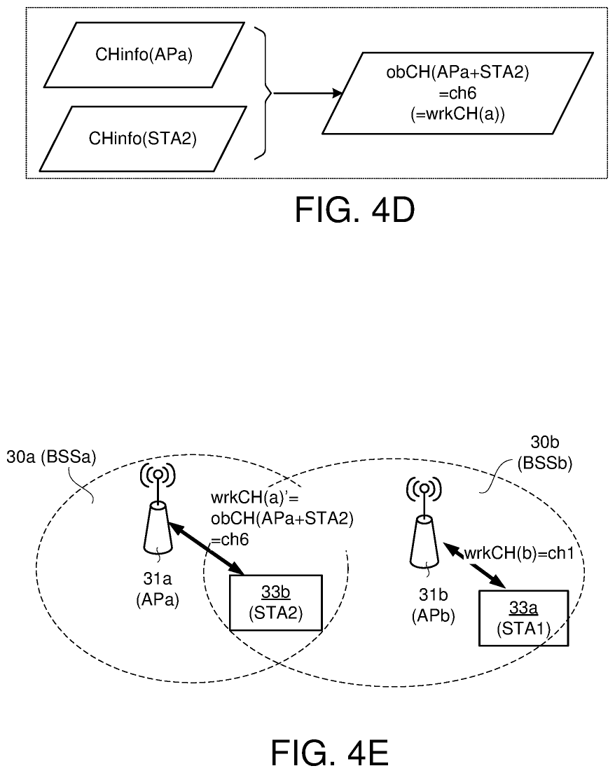

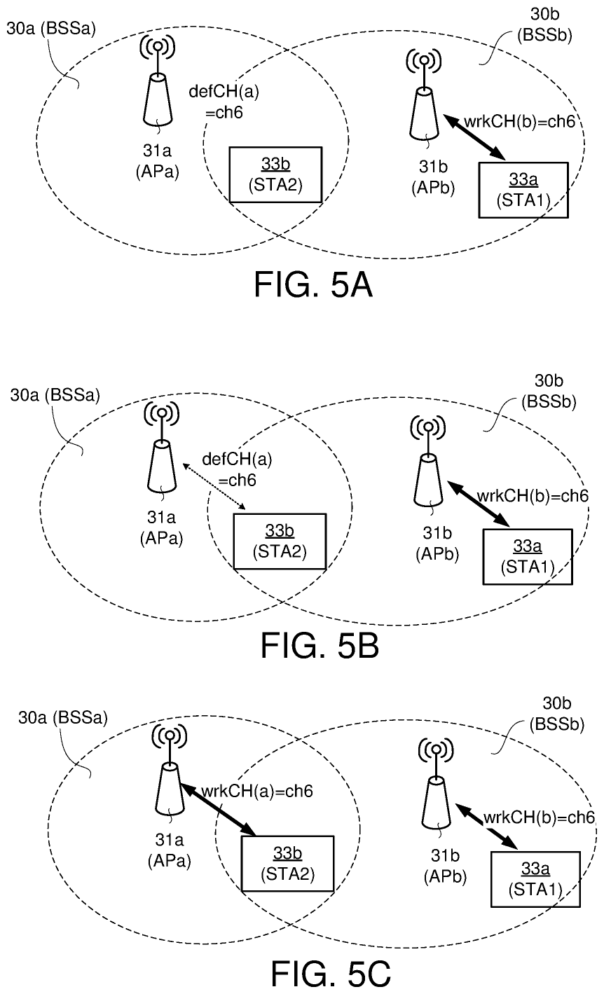

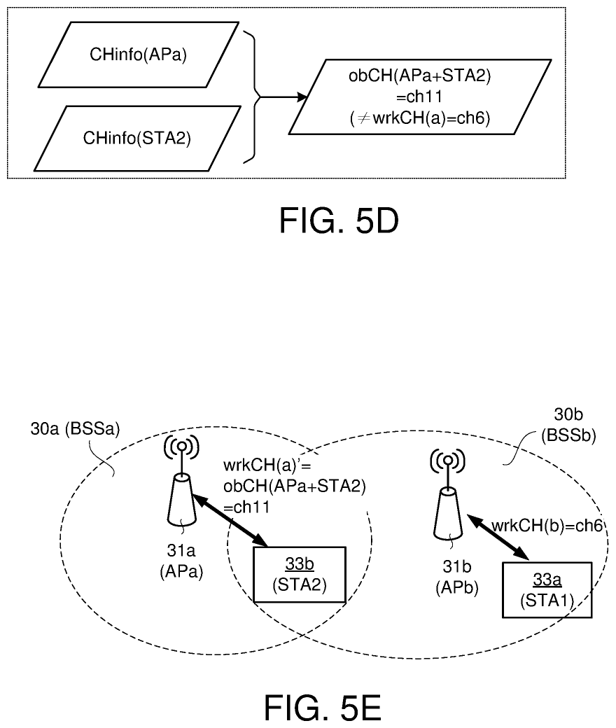

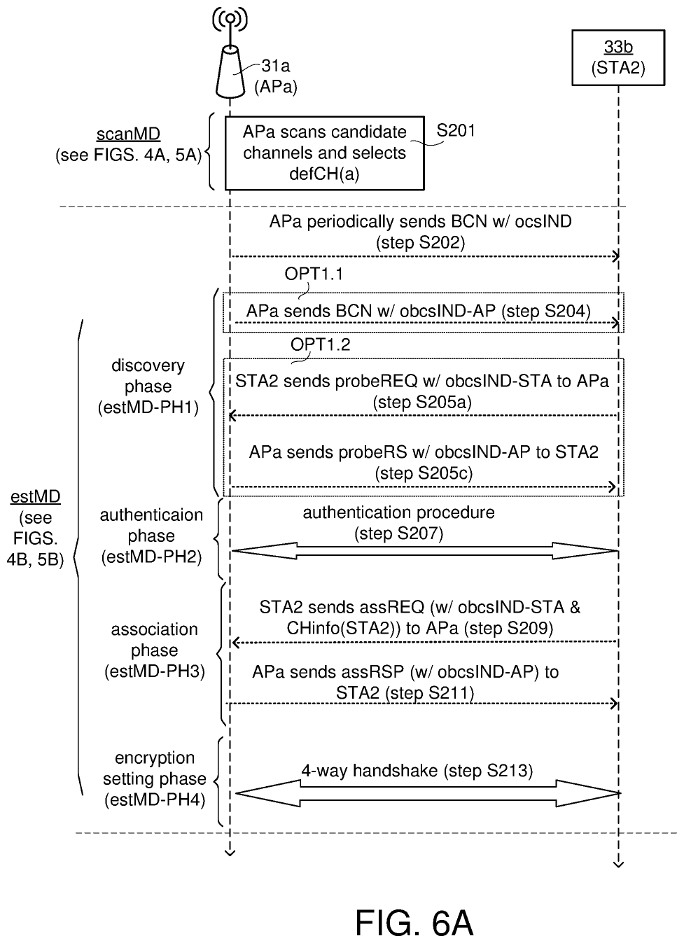

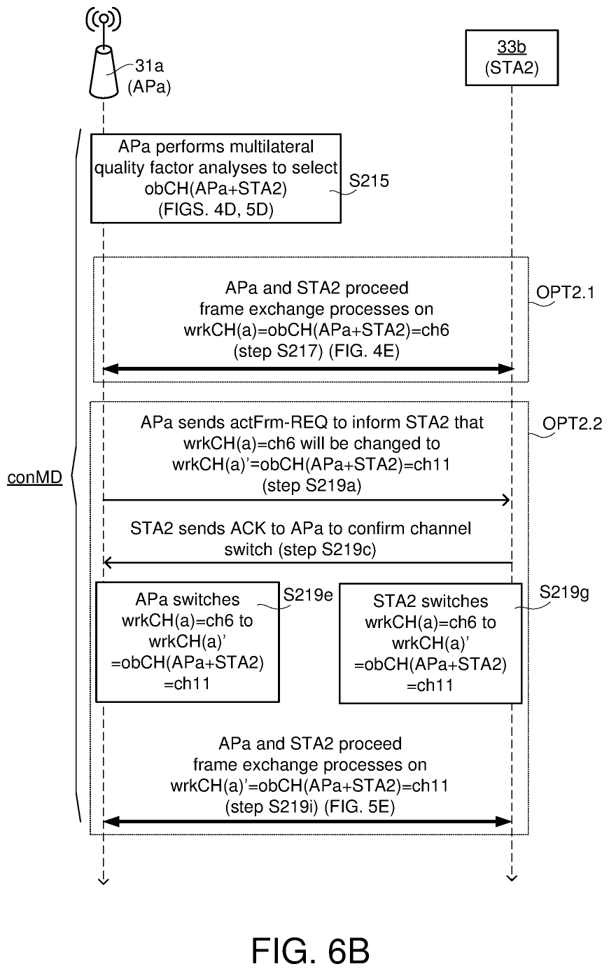

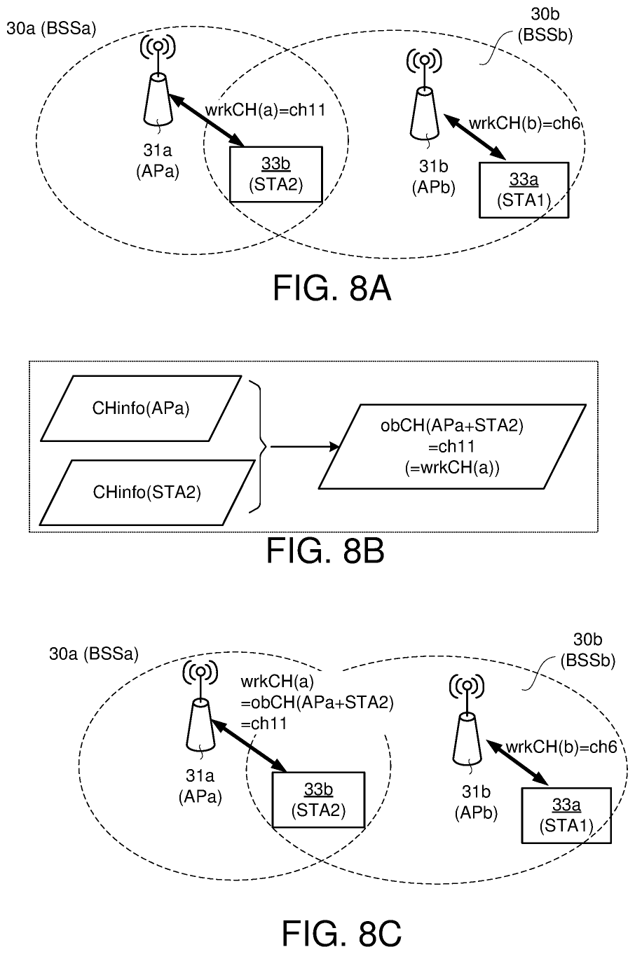

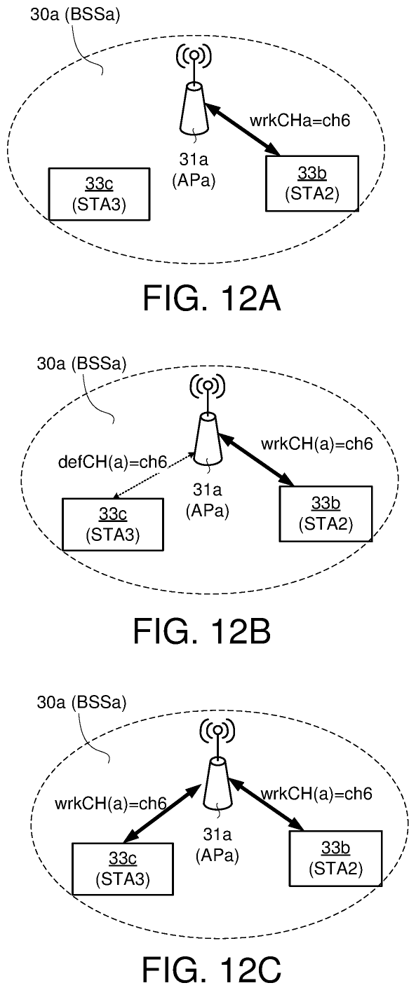

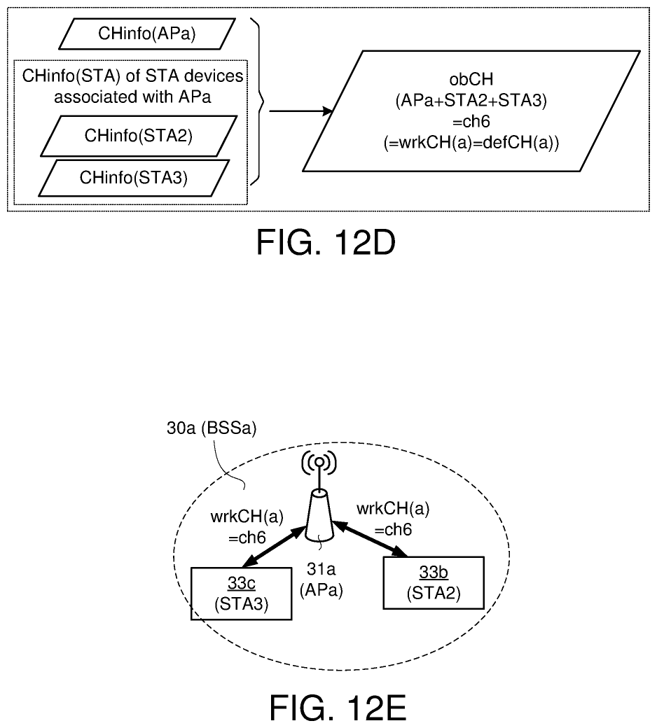

FIGS. 4˜7 are drawings showing that the STA2 device 33b transmits the STA-side channel capability information CHinfo(STAs) in the connection establishment mode (estMD). FIGS. 8˜11 are drawings showing that the STA2 transmits the STA-side channel capability information CHinfo(STA2) in the connected mode (conMD). FIGS. 12A˜12E are drawings showing that the APa device 31a selects the updated working channel wrkCH(a)′ based on AP-side channel capability information CHinfo(APa) and multiple STA-side channel capability information CHinfo(STA2), CHinfo(STA3).

In FIGS. 4A˜4E and 5A˜5E, it is assumed that the BSSa 30a corresponds to the APa device 31a, the BSSb 30b corresponds to the APb device 31b, and the coverage area of the BSSa 30a and that of the BSSb 30 are partially overlapped.

The descriptions in FIGS. 4A˜4E and 5A˜5E focus on the association relationship between the APa device 31a and the STA2 device 33b. Thus, the connection between the APb device 31b and the STA1 device 33a is assumed to be built and stably maintained on Wi-Fi channel ch1 in FIGS. 4A˜4E and on Wi-Fi channel ch6 in FIGS. 5A˜5E.

In the specification, the Wi-Fi channel selected by the APa device 31a is defined as an optimized BSS channel obCH. Moreover, brackets and device symbols are added to represent the origin devices from which the channel information is collected.

For example, the optimized BSS channel obCH(APa+STA2) represents the Wi-Fi channel that APa device 31a considers as the most appropriate Wi-Fi channel, based on comprehensive multilateral quality factor analyses of the AP channel information CHinfo(APa) and the STA channel information CHinfo(STA2). On occasions that the APa device 31a is connected to multiple STA devices, the number of device symbols represented in the brackets increases as well.

According to the embodiments of the present disclosure, the STA2 device 33b may collect the STA-side channel capability information CHinfo(STA2) in the connection establishment mode (estMD) or in the connected mode (conMD). FIGS. 4˜7 are examples showing the APa device 31a receives the STA-side channel capability information CHinfo(STA2) in the connection establishment mode (estMD), and FIGS. 8˜11 are examples showing the APa device 31a receives the STA-side channel capability information CHinfo(STA) in the connected mode (conMD).

In both types of examples, the APa device 31a performs multilateral quality factor analyses to select the optimized BSS channel obCH(APa+STA2) based on the reported STA-side channel capability information CHinfo(STA2) and the private AP-side channel capability information CHinfo(APa). If the optimized BSS channel obCH(Apa+STA2) is consistent with the current working channel wrkCH(a), no channel switch procedure is required. Otherwise, if the current optimized BSS channel obCH(APa+STA2) is different from the working channel wrkCH(a), the APa device 31a and the STA2 device 33b need to perform the channel switch procedure so that an updated optimized BSS channel obCH(APa+STA2)′ is utilized later in the connected mode (conMD).

FIGS. 4A˜4E are schematic diagrams illustrating that the default channel defCH(a)=ch6, selected by the APa device in the connection establishment mode (estMD), is directly utilized as the current working channel wrkCH(a)=ch6, and Wi-Fi channel ch6 is continuously used in the connected mode (conMD) because the current working channel wrkCH(a)=ch6 is consistent with the optimized BSS channel obCH(APa+STA2)=ch6, as determined by the APa device based on the STA-side channel capability information CHinfo(STA2) and the AP-side channel capability information CHinfo(APa). Please refer to FIGS. 4A˜4E together. For the sake of illustration, it is assumed in FIGS. 4A˜4E that the APb device 31b and the STA1 device 13a remain in the connected mode (conMD), and the working channel wrkCH(b) corresponding to the BSSb 30b is Wi-Fi channel ch1. That is, wrkCH(b)=ch1.

In FIG. 4A, the APa device 31a scans the candidate Wi-Fi channels and selects Wi-Fi channel ch6 as the default channel defCH(a)=ch6. In FIG. 4A, the default channel corresponding to the BSSa 30a defCH(a)=ch6 is different from the working channel corresponding to the BSSb 30b wrkCH(b)=ch1. FIG. 4B shows that the APa device 31a and the STA2 device 33b exchange association-related information on the default channel defCH(a)=ch6 during the connection establishment mode (estMD). By the time the connection establishment mode (estMD) is complete, the default channel defCH(a)=ch6 becomes the current working channel wrkCH(a)=ch6.

As the BSSa 30a uses Wi-Fi channel ch6 as its current working channel wrkCH(a)=ch6 and the BSSb 30b uses Wi-Fi channel ch1 as its current working channel wrkCH(b)=ch1, no conflict will occur between the BSSa 30a and the BSSb 30b in FIG. 4C. In the connected mode (conMD), the APa device 31a receives the STA-side channel capability information CHinfo(STA2) from the STA2 device 33b. Then, the APa device 31a analyzes the AP-side channel capability information CHinfo(APa) and the STA-side channel capability information CHinfo(STA2) to determine the optimized BSS channel obCH(APa+STA2). As the STA-side channel capability information CHinfo(STA2) also indicates that the Wi-Fi channel ch6 is not used by the BSSb 30b, the BSSa 30a does not need to switch to another Wi-Fi channel, and the optimized BSS channel obCH(APa+STA2) selected in FIG. 4D is identical to the current working channel wrkCH(a)=ch6. That is, wrkCH(a)=obCH(APa+STA2)=ch6.

The association relationship between the APa device 31a and the STA2 device 33b, the association relationship between the APb device 31b and the STA1 device 33a, and operations of the APa, STA2, APb, and STA2 devices in FIGS. 4A˜4E are summarized in Table 5.

TABLE 5

| | APa and STA2 | | APb and STA1 | |
|---|---|---|---|---|
| | association | | association | |
| drawings | relationship | operations | relationship | operations |
| FIG. 4A | scanning | APa scans medium | connected | Wi-Fi channel |
| | mode | environment and | mode | ch1 is |
| | (scanMD) | selects default | (conMD) | continuously |
| | | channel | | used as |
| | | defCH(a) = ch6 | | working |
| FIG. 4B | connection | APa and STA2 | | channel |
| | establishment | exchange | | wrkCH(b) |
| | mode | association-related | | (wrkCH(b) = ch1) |
| | (estMD) | information on default | | |
| | | channel | | |
| | | defCH(a) = ch6 | | |
| FIG. 4C | connected | APa and STA2 | | |
| | mode | perform frame | | |
| | (conMD) | exchange procedures | | |
| | | on current working | | |
| | | channel | | |
| | | wrkCH(a) = ch6 | | |
| FIG. 4D | | APa analyzes | | |
| | | AP-side channel | | |
| | | capability information | | |
| | | CHinfo(APa) and | | |
| | | STA-side channel | | |
| | | capability information | | |
| | | CHinfo(STA2) to | | |
| | | determine optimized | | |
| | | BSS channel | | |
| | | obCH(APa + STA2) = ch6 | | |
| FIG. 4E | | APa and STA2 | | |
| | | continuously perform | | |
| | | frame exchange | | |
| | | procedures on | | |
| | | working channel | | |
| | | wrkCH(a) = ch6 | | |

FIGS. 5A˜5E are schematic diagrams illustrating that, although the default channel defCH(a)=ch6, previously selected by the APa device in the connection establishment mode (estMD), is directly utilized as the current working channel wrkCH(a)=ch6. Wi-Fi channel ch6 is no longer used in the connected mode (conMD) because the current working channel wrkCH(a)=ch6 is different from the optimized BSS channel obCH(APa+STA2)=ch11, as determined by the APa device based on the STA-side channel capability information CHinfo(STA2) and the AP-side channel capability information CHinfo(APa). Please refer to FIGS. 5A˜5E together. For the sake of illustration, it is assumed in FIGS. 5A˜5E that the APb device 31b and the STA1 device 13a remain in the connected mode (conMD), and the working channel wrkCH(b) corresponding to the BSSb 30b is Wi-Fi channel ch6. That is, wrkCH(b)=ch6.

In FIG. 5A, the APa device 31a scans the candidate Wi-Fi channels and selects Wi-Fi channel ch6 ass the default channel defCH(a)=ch6. In FIG. 5A, the default channel defCH(a)=ch6 in BSSa 30a is identical to the working channel wrkCH(b)=ch6 in BSSb 30b. FIG. 5B shows that the APa device 31a and the STA2 device 33b exchange association-related information on the default channel defCH(a)=ch6 during the connection establishment mode (estMD). By the time the connection establishment mode (estMD) is complete, the BSSa 30a keeps on using the default channel defCH(a)=ch6 as the current working channel wrkCH(b)=ch6.

As both the BSSa 30a and the BSSb 30b use Wi-Fi channel ch6 as their working channel wrkCH(a), wrkCH(b), conflict will occur between the BSSa 30a and the BSSb 30b in FIG. 5C. In the connected mode (conMD), the APa device 31a receives the STA-side channel capability information CHinfo(STA2) from the STA2 device 33b. Then, the APa device 31a analyzes the AP-side channel capability information CHinfo(APa) and the STA-side channel capability information CHinfo(STA2) to determine the optimized BSS channel obCH(APa+STA2). Based on the STA-side channel capability information CHinfo(STA2), the APa device 31a could indirectly know that Wi-Fi channel ch6 is used by BSSb 30b. To avoid the potential conflict, the APa device 31a knows that Wi-Fi channel ch6 is not appropriate for BSSa 30a. Accordingly, the APa device 31a will not select Wi-Fi channel ch6 as the optimized BSS channel obCH(APa+STA2). Instead, the APa device 31a selects another Wi-Fi channel (for example, ch11) as the optimized BSS channel obCH(APa+STA2) in FIG. 5D. Therefore, the current working channel corresponding to the BSSa 30a is different from the optimized BSS channel obCH(APa+STA2). That is, wrkCH(a)=ch6≠obCH(APa+STA2)=ch11. FIG. 5E shows that Wi-Fi channel ch11 is utilized as the updated working channel wrkCH(a)′ in the BSSa 30a.

The association relationship between the APa device 31a and the STA2 device 33b, the association relationship between the APb device 31b and the STA1 device 33a, and operations of the APa, STA2, APb, and STA2 devices in FIGS. 5A˜5E are summarized in Table 6.

TABLE 6

| | APa and STA2 | | APb and STA1 | |
|---|---|---|---|---|
| | association | | association | |
| drawings | relationship | operations | relationship | operations |
| FIG. 5A | scanning | APa scans medium | connected | Wi-Fi channel |
| | mode | environment and | mode | ch6 is |
| | (scanMD) | selects default | (conMD) | continuously |
| | | channel defCH(a) = ch6 | | used as |
| FIG. 5B | connection | APa and STA2 | | working |
| | establishment | exchange | | channel |
| | mode | association-related | | wrkCH(b) |
| | (estMD) | information on default | | (wrkCH(b) = ch6) |
| | | channel defCH(a) = ch6 | | |
| FIG. 5C | connected | APa and STA2 | | |
| | mode | perform frame | | |
| | (conMD) | exchange procedures | | |
| | | on current working | | |
| | | channel | | |
| | | wrkCH(a) = ch6 | | |
| FIG. 5D | | APa analyzes AP-side | | |
| | | channel capability | | |
| | | information | | |
| | | CHinfo(APa) and | | |
| | | STA-side channel | | |
| | | capability information | | |
| | | CHinfo(STA2) to | | |
| | | determine optimized | | |
| | | BSS channel | | |
| | | obCH(APa+STA2) = ch11 | | |
| FIG. 5E | | APa and STA2 | | |
| | | continuously perform | | |
| | | frame exchange | | |
| | | procedures on | | |
| | | updated working | | |
| | | channel | | |
| | | wrkCH(a)′ = ch11 | | |

FIGS. 4A˜4E and 5A˜5E represent examples that the STA device reporting its channel capability information CHinfo(STA) to the APa device 31a in the connection establishment mode (estMD). Then, the STA-side channel capability information CHinfo(STA) is referred to by the APa device 31a in the connected mode (conMD) to determine the optimized BSS channel obCH(APa+STA2).

If the optimized BSS channel obCH(APa+STA2) is identical to the current working channel wrkCH(a) (obCH(APa+STA2)=wrkCH(a)), the APa device 31a and the STA2 device 33b continue to perform frame exchange procedures on the current working channel wrkCH(a) (see FIGS. 4A˜4E). If the optimized BSS channel obCH(APa+STA2) is different from the current working channel wrkCH(a) (obCH(APa+STA2)≠wrkCH(a)), the APa device 31a and the STA2 device 33b no longer perform frame exchange procedures on the current working channel wrkCH(a) (see FIGS. 5A˜5E). Instead, the optimized BSS channel obCH(APa+STA2) is set as the updated working channel wrkCH(a)′. Then, the APa device 31a and the STA2 device 33b switch to the updated working channel wrkCH(a)′ and perform the following frame exchange procedures on the updated working channel wrkCH(a)′.

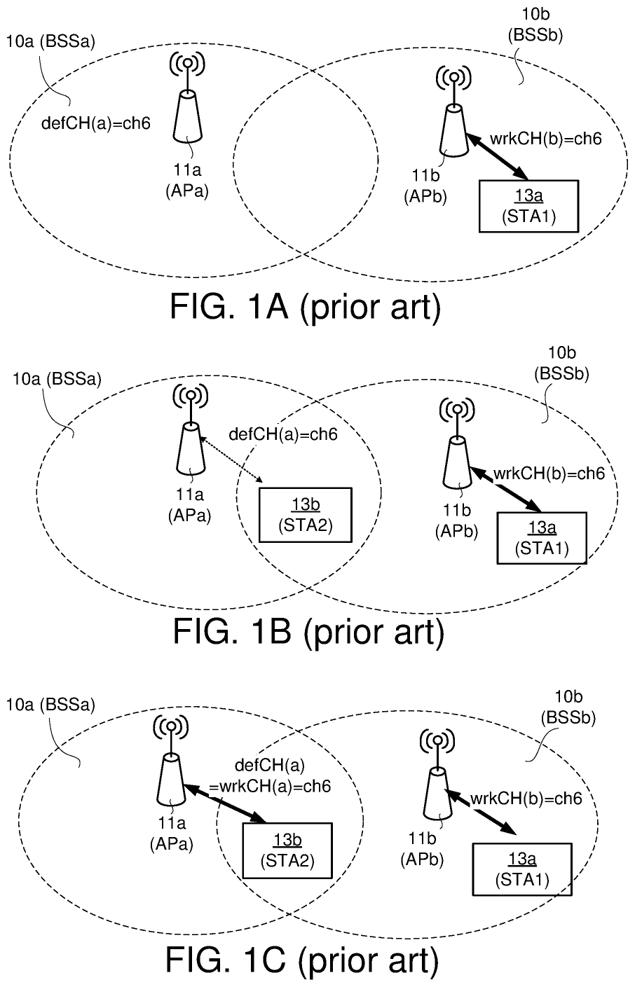

Please compare FIG. 1C with FIG. 5E. In both FIGS. 1C and 5E, the APb device 11b, 31b is connected to the STA1 device 13a, 33a on Wi-Fi channel ch6. Whereas, the APa device 11a in FIG. 1C is in communication with the STA2 device 13b on Wi-Fi channel ch6, but the APa device 31a in FIG. 5E is in communication with the STA2 device 33b on Wi-Fi channel ch 11. Potential conflict occurs on Wi-Fi channel ch6 in FIG. 1C because Wi-Fi channel ch6 is occupied by both BSSa 10a and BSSb 10b. In contrast, the conflict will not occur in FIG. 5E because the BSSa 30a and BSSb 30b use separate and independent Wi-Fi channels ch11, ch6.

According to the embodiments of the present disclosure, either the APa device 31a or the STA2 device 33b can initiate the channel capability reporting mechanism in the connection establishment mode (estMD). More details about the interactions between the APa device 31a and the STA2 device 33b in FIGS. 4A˜4E and 5A˜5E are described in FIGS. 6A˜6B and 7A˜7C.

FIGS. 6A and 6B are schematic diagrams illustrating the association relationship between the APa device and the STA2 device regarding how the working channel wrkCH(a) is determined based on the STA-side channel capability information CHinfo(STA2) collected in the connection establishment mode (estMD). In FIGS. 6A and 6B, the vertical dotted arrows toward the bottom represent the timing sequence. The steps performed by APa device 31a are listed on the left side in the chronicle order, and the steps performed by STA2 device 33b are listed on the right side in the chronicle order. The arrows toward the right represent the frames sent from the APa device 31a to the STA2 device 33b. The arrows toward the left represent the frames sent from the STA2 device 33b to the APa device 31a.

FIGS. 7A˜7C is a flow diagram illustrating the operations and interactions between the APa device and the STA2 device regarding how the working channel wrkCH(a) is determined based on the STA-side channel capability information CHinfo(STA2) collected in the connection establishment mode (estMD). In FIGS. 6A and 6B, the signal transmission directions between the APa device 31a and the STA2 device 33b are shown. Whereas, FIGS. 7A˜7C focus on the operations of the APa device 31a and the STA2 device 33b. Please refer to FIGS. 4A˜4E, 5A˜5E, 6A, 6B, and 7A˜7C together.

In the scanning mode (scanMD), the APa device 31a scans candidate Wi-Fi channels and selects the default channel defCH(a) (step S201). Then, the APa device 31a periodically sends a beacon frame (BCN) with an off-channel scanning indicator (ocsIND) on the default channel defCH(a) (step S202) in the connection establishment mode (estMD). The connection establishment mode (estMD) further includes a discovery phase (estMD-PH1), an authentication phase (estMD-PH2), an association phase (estMD-PH3), and an encryption setting phase (estMD-PH4).

According to the embodiments of the present disclosure, the protocols performed in the discovery phase (estMD-PH1) and the association phase (estMD-PH3) can be slightly modified to support the channel capability reporting mechanism. To be more specific, the frames transmitted in the discovery phase (estMD-PH1) and the association phase (estMD-PH3) can be selectively modified to carry optimized BSS channel selection indicators (obcsIND) and/or the capability reporting frame (capRpFrm). Based on the interchanged optimized BSS channel selection indicators (obcsIND) and/or the capability reporting frame (capRpFrm), the APa device 31a can receive the scanning result of the medium environment made by the STA2 device 33b.

In the discovery phase (estMD-PH1), either the APa device 31a or the STA2 device 33b may initiate the channel capability reporting mechanism. In step S203, whether the STA2 device 33b actively initiates the channel capability reporting mechanism is determined.

If the determination result of step S203 is negative, the APa device 31a embeds an AP-side optimized BSS channel selection indicator (obcsIND-AP) in a beacon frame BCN (option OPT1.1, step S204). If the determination result of step S203 is positive, the APa device 31a and the STA2 device 33b perform the option OPT1.2 (step S205).

In a case that the STA2 device 33b actively initiates the channel capability reporting mechanism, the STA2 device 33b sends a probe request (probeREQ) frame, by which an STA-side optimized BSS channel selection indicator (obcsIND-STA) is carried, to notify the APa device 31a (step S205a). According to the STA-side optimized BSS channel selection indicator (obcsIND-STA), APa device 31a knows that STA2 device 33b supports the channel capability reporting mechanism. Thus, the APa device 31a sends a probe response (probeRS) frame in response (step S205c). The probe response (probeRS) frame includes the AP-side optimized BSS channel selection indicator (obcsIND-AP).

After steps S204 and S205c are performed, the authentication procedure is performed (step S207). Details about the authentication procedure can be referred to Wi-Fi standards. Then, depending on whether the authentication procedure is successfully proceeded (step S208), the association-related flow ends or enters the association phase (estMD-PH3).

In the association phase (estMD-PH3), the STA2 device 33b sends an association request (assREQ) frame to the APa device 31a (step S209). The association request (assREQ) frame carries an STA-side optimized BSS channel selection indicator (obcsIND-STA) and STA-side channel capability information CHinfo(STA2). Based on the STA-side optimized BSS channel selection indicator (obcsIND-STA), the APa device 31a confirms again that the STA2 device 33b supports the channel capability reporting mechanism. Thus, the APa device 31a parses the association request (assREQ) frame to acquire the STA-side channel capability information CHinfo(STA2).

In response to the association request (assREQ) frame, the APa device 31a sends an association response (assRSP) frame to the STA2 device 33b (step S211). The association response (assRSP) frame has an AP-side optimized BSS channel selection indicator (obcsIND-AP) as well. According to the embodiment of the present disclosure, the channel capability reporting mechanism in the connection establishment mode (estMD) can be considered complete after step S211 is complete.

After step S211, the 4-way handshake procedure is performed (step S213). Details about the 4-way handshake procedure can be referred to Wi-Fi standards. Then, depending on whether step S213 is successful (step S214), the association-related flow ends, or the APa device 31a and the STA2 device 33b enter the connected mode (conMD).

In the connected mode (conMD), the APa device 31a firstly performs multilateral quality factor analyses based on the STA-side channel capability information CHinfo(STA2) and the AP-side channel capability information CHinfo(APa) to select the optimized BSS channel obCH(APa+STA2) (step S215). The wireless control circuit 85 of the APa device 31a checks if the optimized BSS channel obCH(APa+STA2) and the working channel wrkCH(a) are identical (step S216).

If the determination result of step S216 is positive, the APa device 31a and the STA2 device 33b perform the option OPT2.1 (step S217). The option OPT2.1 corresponds to the scenario shown in FIGS. 4D and 4E. That is, the STA2 device 33b reports in the STA-side channel capability information CHinfo(STA2) that the working channel wrkCH(a) is good for the BSSa 30a as well. Thus, the APa device 31a determines to select the same Wi-Fi channel (that is, ch6) as the working channel wrkCH(a) corresponding to BSSa 30a. That is, wrkCH(a)=obCH(APa+STA2)=ch6.

If the determination result of step S216 is negative, the APa device 31a and the STA2 device 33b perform the option OPT2.2 (step S219). The option OPT2.2 corresponds to FIGS. 5D and 5E. Firstly, the APa device 31a sends a request action (actFrm-REQ) frame to inform the STA2 device 33b that the current working channel wrkCH(a)=ch6 will be changed/updated to the newly determined optimized BSS channel obCH(APa+STA2)=ch11 (step S219a). That is, wrkCH(a)′=obCH(APa+STA2)=ch11.

After receiving the request action (actFrm-REQ) frame, the STA2 device 33b sends an acknowledgment frame (ACK) to the APa device 31a to confirm the channel switch (step S219c). Then, both the APa device 31a and the STA2 device 33b switch to the updated working channel wrkCH(a)′=ch11 (steps S219e, S219g). Details about the execution of the channel switch procedure can be referred to the Wi-Fi standards.

The request action (actFrm-REQ) frame includes a channel switch announcement (CSA.IE). Optionally, the request action (actFrm-REQ) frame may include a quiet period information element (QUIET.IE). With the request action (actFrm-REQ) frame, the STA2 device 33b can hop to the optimized BSS channel obCH(APa+STA2)=ch11 in which the APa device 31a is hopping to and maintain the connection with the APa device 31a. After the channel switch procedure (steps S219e, S219g) is complete, the APa device 31a and the STA2 device 33b perform frame exchange procedures on the updated working channel wrkCHa′=obCH(APa+STA2)=ch11 (step S219i).

FIGS. 4˜7 demonstrate that the STA-side channel capability information CHinfo(STA) can be collected and transmitted to the AP device in the connection establishment mode (estMD). In FIGS. 8˜11, the procedures of collecting and transmitting the STA-side channel capability information CHinfo(STA) in the connected mode (conMD) are described.

As the media environment might change, a Wi-Fi channel having good quality by the time that the AP device selects the default channel defCH in the connection establishment mode (estMD) might become worse during the connected mode (conMD). According to the embodiment of the present disclosure, the STA2 device 33b is aware whether the Wi-Fi channel corresponding to the working channel wrkCH(a) becomes being utilized in the BSSb 30b in the connected mode (conMD), as the STA2 device 33b is physically located in the overlapped coverage area of the BSSa 30a and the BSSb 30b. Thus, the STA2 device 33b according to the embodiment of the present disclosure can report the up-to-date STA-side channel capability information CHinfo(STA2), regarding whether Wi-Fi channel ch11 suffers conflict in the connected mode (conMD), to the APa device 31a. In response to the up-to-date STA-side channel capability information CHinfo(STA2), the APa device 31a according to the embodiment of the present disclosure continuously and repetitively performs the multilateral quality factor analyses to update the optimized BSS channel obCH(APa+STA2).

By doing so, the Wi-Fi channel corresponding to the working channel wrkCH(a) is freely and selectively changed, and the potential conflict that the BSSa 30a and the BSSb 30b use the same Wi-Fi channel as their working channels wrkCH(a), wrkCH(b) can be avoided. In other words, both the BSSa 30a and the BSSb 30b can provide relatively clean medium environment for frame exchange procedures. In practical applications, the APb device 31b and the STA1 device 33a in BSSb 30b can be the conventional Wi-Fi system or the Wi-Fi system according to the embodiment of the present disclosure.

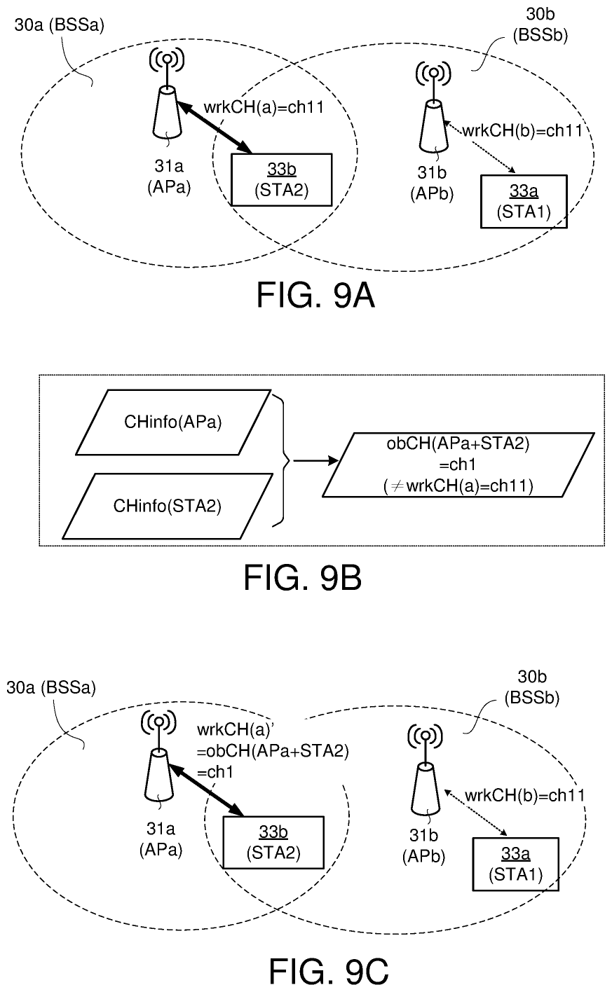

During the connected mode (conMD), the STA2 device 33b might actively or passively update its STA-side channel capability information CHinfo(STA2) to the APa device 31a. Based on such an update, the APa device 31a evaluates which of the Wi-Fi channels is the most appropriate one for BSSa 30a and determines whether the current working channel wrkCH(a) should be changed. FIGS. 8A˜8C are examples showing that the working channel wrkCH(a) does not need to be changed, and FIGS. 9A˜9C are examples showing that the working channel wrkCH(a) needs to be changed. Please refer to FIGS. 8A˜8C together. The descriptions in FIGS. 8A˜8C and 9A˜9C focus on the association relationship between the APa device 31a and the STA2 device 33b. Thus, the connection between the APb device 31b and the STA1 device 33a is assumed to be built and stably maintained on Wi-Fi channel ch6 in FIGS. 8A˜8C and Wi-Fi channel ch11 in FIGS. 9A˜9C.

FIGS. 8A˜8C are schematic diagrams illustrating that Wi-Fi channel ch11 is continuously used in the connected mode (conMD) because the current working channel wrkCH(a)=ch11 is consistent with the optimized BSS channel obCH(APa+STA2)=ch11, which is determined by the APa device based on the STA-side channel capability information CHinfo(STA2) and the AP-side channel capability information CHinfo(APa) collected in the connected mode (conMD). Please refer to FIGS. 8A˜8C together. For the sake of illustration, it is assumed in FIGS. 8A˜8E that the APb device 31b and the STA1 device 13a remain in the connected mode (conMD), and the current working channel wrkCH(b) corresponding to the BSSb 30b is Wi-Fi channel ch6. That is, wrkCH(b)=ch6.

In FIG. 8A, the APa device 31a is connected to the STA2 device 33b on Wi-Fi channel ch11, and the APb device is connected to the STA1 device on Wi-Fi channel ch11. By analyzing the STA-side channel capability information CHinfo(STA2) and the AP-side channel capability information CHinfo(APa), the APa device 31a knows that Wi-Fi channel ch11 is still clean and appropriate for data transfer. Thus, the APa device 31a again selects Wi-Fi channel ch11 as the optimized BSS channel obCH(APa+STA2) in FIG. 8B. That is, wrkCH(a)=obCH(APa+STA2)=ch11. FIG. 8C shows that Wi-Fi channel ch11 is continuously utilized as the working channel wrkCH(a).

The association relationship between the APa device 31a and the STA2 device 33b, the association relationship between the APb device 31b and the STA1 device 33a, and operations of the APa, STA2, APb, and STA2 devices in FIGS. 8A˜8C are summarized in Table 7.

TABLE 7

| | APa and STA2 | | APb and STA1 | |
|---|---|---|---|---|
| | association | | association | |
| drawings | relationship | operations | relationship | operations |
| FIG. 8A | connected | APa and STA2 perform | connected | Wi-Fi channel |
| | mode | frame exchange | mode | ch6 is |
| | (conMD) | procedures on working | (conMD) | continuously |
| | | channel | in FIGS. | used as |
| | | wrkCH(a) = ch11 | 8A~8C | working |
| | | | | channel |
| FIG. 8B | | APa analyzes AP-side | | wrkCH(b) in |
| | | channel capability | | FIGS. 8A~8C |
| | | information | | (wrkCH(b) = ch6) |
| | | CHinfo(APa) and | | |
| | | STA-side channel | | |
| | | capability information | | |
| | | CHinfo(STA2) to | | |
| | | determine optimized | | |
| | | BSS channel | | |
| | | obCH(APa + STA2) = ch11 | | |
| FIG. 8C | | APa and STA2 | | |
| | | continuously perform | | |
| | | frame exchange | | |
| | | procedures on working | | |
| | | channel | | |
| | | wrkCH(a) = ch11 | | |

FIGS. 9A˜9C are schematic diagrams illustrating that, instead of using Wi-Fi channel ch11 in the connected mode (conMD), Wi-Fi channel ch6 is used because the current working channel wrkCH(a)=ch11 is different from the optimized BSS channel obCH(APa+STA2)=ch6, which is determined by the APa device based on the STA-side channel capability information CHinfo(STA2) and the AP-side channel capability information CHinfo(APa) collected in the connected mode (conMD). Please refer to FIGS. 9A˜9C together. For the sake of illustration, it is assumed in FIGS. 9A˜9E that the APb device 31b and the STA1 device 13a remain in the connected mode (conMD), and the working channel wrkCH(b) corresponding to the BSSb 30b is Wi-Fi channel ch11. That is, wrkCH(b)=ch11.

In FIG. 9A, the APa device 31a is connected to the STA2 device 33b on Wi-Fi channel ch11, and the APb device is connected to the STA1 device 33a on Wi-Fi channel ch11. By collecting the STA-side channel capability information CHinfo(STA2), the APa device 31a knows that other BSS also oppupies Wi-Fi channel ch11. Thus, the APa device 31a selects Wi-Fi channel ch1 as the optimized BSS channel obCH(APa+STA2) in FIG. 9B. That is, obCH(APa+STA2)=ch1. As the optimized BSS channel obCH(APa+STA2)=ch1 is different from the current working channel wrkCH(a)=ch11, the APa device 31a and the STA2 device 33b perform the channel switch procedure. After the channel switch procedure is complete, FIG. 9C shows that the BSSa 30a utilizes Wi-Fi channel ch1 as the updated working channel wrkCH(a) .

The association relationship between the APa device 31a and the STA2 device 33b, the association relationship between the APb device 31b and the STA1 device 33a, and operations of the APa, STA2, APb, and STA2 devices in FIGS. 9A˜9C are summarized in Table 8.

TABLE 8

| | APa and STA2 | | APb and STA1 | |
|---|---|---|---|---|
| | association | | association | |
| drawings | relationship | operations | relationship | operations |
| FIG. 9A | connected | APa and STA2 | connected | Wi-Fi channel |
| | mode | perform frame | mode | ch6 is |
| | (conMD) | exchange procedures | (conMD) | continuously |
| | | on working channel | in FIGS. | used as |
| | | wrkCH(a) = ch11 | 8A~8C | working |
| FIG. 9B | | APa analyzes AP-side | | channel |
| | | channel capability | | wrkCH(b) in |
| | | information | | FIGS. 9A~9C |
| | | CHinfo(APa) and | | (wrkCH(b) = ch6) |
| | | STA-side channel | | |
| | | capability information | | |
| | | CHinfo(STA2) to | | |
| | | determine optimized | | |
| | | BSS channel | | |
| | | obCH(APa + STA2) = ch1 | | |
| FIG. 9C | | APa and STA2 | | |
| | | continuously perform | | |
| | | frame exchange | | |
| | | procedures on working | | |
| | | channel | | |
| | | wrkCH(a) = ch1 | | |

For the sake of illustrations, the embodiments in FIGS. 8A˜8C and 9A˜9C assume that only STA2 device 33b is associated with the APa device 31a. Nevertheless, according to the embodiments of the present disclosure, the AP device might be associated with multiple STA devices, and the STA-side channel capability information CHinfo(STA) received and analyzed by the AP device might originate from multiple STA devices. An example of the AP device being associated with two STA devices in the meantime is shown in FIGS. 12A˜12E.

FIGS. 10A and 10B are a schematic diagram illustrating how the APa device determines whether the current working channel wrkCH(a) should be switched based on the comparison between the current working channel wrkCH(a) and the optimized BSS channel obCH(Apa+STA2), wherein the optimized BSS channel obCH(Apa+STA2) is determined by referring to the STA-side channel capability information CHinfo(STA2) collected in the connected mode (conMD). In FIGS. 10A and 10B, the usages of the arrows, labels, and symbols are like those used in FIGS. 6A and 6B.

FIGS. 11A and 11B are a flow diagram illustrating how the APa device determines whether the current working channel wrkCH(a) should be switched based on the comparison between the current working channel wrkCH(a) and the optimized BSS channel obCH(APa+STA2), wherein the optimized BSS channel obCH(APa+STA2) is determined by referring to the STA-side channel capability information CHinfo(STA2) collected in the connected mode (conMD). In FIGS. 10A and 10B, the signal transmission directions between the APa device 31a and the STA2 device 33b are shown. Whereas, FIGS. 11A and 11B focus on operations of the APa device 31a and the STA2 device 33b. Please refer to FIGS. 8A˜8C, 9A˜9C, 10A, 10B, 11A, and 11B together.

Firstly, whether the STA2 device 33b actively sends an optimized BSS channel request (obCH-REQ) frame to the APa device 31a is determined (step S402). Suppose the determination result of step S402 is positive, the Wi-Fi system performs the option OPT3.1. In that case, the STA2 device 33b transmits the optimized BSS channel request (obCH-REQ) frame, including STA-side channel capability information CHinfo(STA2), to the APa device 31a (step S401). The optimized BSS channel request (obCH-REQ) frame in step S401 can use the structure of the capability reporting frame (capRpFrm), as explained in FIGS. 2A and 2B, to carry the STA-side channel capability information CHinfo(STA2).

If the determination result of step S402 is negative, the APa device 31a and the STA2 device 33b perform the option OPT3.2. The APa device 31a transmits a query-ask frame of the optimized BSS channel (obCH-Q-ASK) to the STA2 device 33b (step S4031). According to the embodiments of the present disclosure, the query-ask frame of the optimized BSS channel (obCH-Q-ASK) may selectively carry parameters to query for specific band(s) or Wi-Fi channels and/or parameters to query for specific characteristics of Wi-Fi channels.

The parameters to query for specific band(s) or Wi-Fi channels can be, for example, using Wi-Fi channels in the 5 GHz band only, using Wi-Fi channels ch1˜ch6 only, and so forth. The parameters to query for specific characteristics of Wi-Fi channels can be, for example, BSS number, channel idle ratio only, channel idle/busy time, CCA, transmitting/receiving status, device number per channel, OBSS numbers, and so forth. The parameters carried by the query-ask frame of the optimized BSS channel (obCH-Q-ASK) help the STA2 device 33b to provide more precise information as required by the APa device 31a. If the STA2 device 33b reports only the parameters specified by the APa device 31a, the multilateral quality factor analyses can proceed more efficiently.

In response to the query-ask frame of the optimized BSS channel (obCH-Q-ASK), the STA2 device 33b transmits a query-reply frame of the optimized BSS channel (obCH-Q-RPLY) to the APa device 31a (step S4033). According to the embodiments of the present disclosure, the query-reply frame of the optimized BSS channel (obCH-Q-RPLY) can be considered a communication interface between the APa device 31a and the STA2 device 33b. According to the query-reply frame of the optimized BSS channel (obCH-Q-RPLY), the APa device 31a knows how the STA2 device 33b reacts to the query-ask frame of the optimized BSS channel (obCH-Q-ASK).

Then, the APa device 31a learns the reactions of the STA2 device 33b based on the query-reply frame of the optimized BSS channel (obCH-Q-RPLY) (step S4035), and the STA2 device 33b selectively transmits the optimized BSS channel request (obCH-REQ) frame to the APa device 31a (step S4037). In short, if the STA2 device 33b has the STA-side channel capability information CHinfo(STA2) ready for report, the STA2 device 33b transmits the query-reply frame of the optimized BSS channel (obCH-Q-RPLY) carrying the STA-side channel capability information CHinfo(STA2). Suppose the STA2 device 33b supports the optimized BSS channel request (obCH-REQ) frame but does not have the STA-side channel capability information CHinfo(STA2) yet. In that case, the STA2 device 33b needs to use the optimized BSS channel request (obCH-REQ) frame later to report the STA-side channel capability information CHinfo(STA2) to the APa device 31a.

Step S4035 further includes the following steps. The APa device 31a checks if the STA2 device 33b supports the optimized BSS channel request (obCH-REQ) frame (step S4035a). The STA2 device 33b can use the query-reply frame of the optimized BSS channel (obCH-Q-RPLY) to indicate it is incapable of responding to the optimized BSS channel request (obCH-REQ) frame to the query-ask frame of the optimized BSS channel (obCH-Q-ASK). For such a case, the APa device 31a does not need to wait to receive the optimized BSS channel request (obCH-REQ) frame, and the association-related flow ends. Thus, the association-related flow ends if the determination result of step S4035a is negative.

If the determination result of step S4035a is positive, the APa device 31a checks in which frame the STA-side channel capability information CHinfo(STA2) is carried (step S4035c). According to the embodiments of the present disclosure, either the query-reply frame of the optimized BSS channel (obCH-Q-RPLY) or the optimized BSS channel request (obCH-REQ) frame can carry the STA-side channel capability information CHinfo(STA2).

Suppose the determination result of step S4035c is positive. In that case, the APa device 31a directly processes the query-reply frame of the optimized BSS channel (obCH-Q-RPLY) to acquire the STA-side channel capability information CHinfo(STA2) (step S405b). That is, the STA2 device 33b may directly use the query-reply frame of the optimized BSS channel (obCH-Q-RPLY) to carry the STA-side channel capability information CHinfo(STA2) if the STA2 device 33b has had the STA-side channel capability information CHinfo(STA2) by the time that the APa device 31a requests for it. Under such circumstances, the APa device 31a does not need to wait for the optimized BSS channel request (obCH-REQ) frame.

If the determination result of step S4035c is negative, the APa device 31a further checks if the STA2 device 33b will update the STA-side channel capability information CHinfo(STA2) (step S4035g). Depending on whether the STA2 device 33b has the updated STA-side channel capability information CHinfo(STA2), the APa device 31a may or may not need to wait for the optimized BSS channel request (obCH-REQ) frame.

In the query-reply frame of the optimized BSS channel (obCH-Q-RPLY), the STA2 device 33b may indicate that the STA-side channel capability information CHinfo(STA2) (being transmitted to the APa device 31a before), as the APa device 31a already has, is up-to-date. Thus, the APa device 31a does not need to wait for the STA2 device 33b to transmit the optimized BSS channel request (obCH-REQ) frame to carry the latest STA-side channel capability information CHinfo(STA2) if the determination result of step S4035g is negative. Instead, the APa device 31a refers to the previously acquired/saved STA-side channel capability information CHinfo(STA2).

According to the embodiment of the present disclosure, the STA2 device 33b may provide a notification/message in the query-reply frame of the optimized BSS channel (obCH-Q-RPLY) indicating that the STA2 device 33b needs some time to collect the latest STA-side channel capability information CHinfo(STA2), and the STA-side channel capability information CHinfo(STA2) will be transmitted in a specified duration (for example, certain milliseconds). Thus, if the determination result of step S4035g is positive, the APa device 31a waits for the specified duration (step S4035i) for the STA2 device 33b to report the STA-side channel capability information CHinfo(STA2).

After the STA2 device 33b transmits the optimized BSS channel request (obCH-REQ) frame to the APa device 31a (steps S401, S4037). The optimized BSS channel request (obCH-REQ) frame in steps 401 and S4037 can adopt the structure of the capability reporting frame (capRpFrm), as explained in FIGS. 2A and 2B, to carry the STA-side channel capability information CHinfo(STA2). Then, the APa device 31a processes the optimized BSS channel request (obCH-REQ) frame to acquire the STA-side channel capability information CHinfo(STA2) (step S405a).

In step S407, the APa device 31a scans the medium environment to collect the AP-side channel capability information CHinfo(APa). The execution order of steps S407, S401, S403˜S405a/S405b is not limited. That is, the APa device 31a may scan the medium environment to collect the AP-side channel capability information CHinfo(APa) before receiving the STA-side channel capability information CHinfo(STA2) from the STA2 device 33b. Or, the APa device 31a may scan the medium environment to collect the AP-side channel capability information CHinfo(APa) while receiving the STA-side channel capability information CHinfo(STA2) from the STA2 device 33b.

After the AP-side channel capability information CHinfo(APa) and the STA-side channel capability information CHinfo(STA2) are ready for the APa device 31a, the APa device 31a performs multilateral quality factor analyses based on an optimization selection algorithm to select the optimized BSS channel obCH(APa+STA2) (step S409) and checks if the working channel wrkCH(a) is consistent with the optimized BSS channel obCH(APa+STA2) (step S410). The optimization selection algorithm may incorporate different/specific considerations of the Wi-Fi system and manage the priorities of the quality factors.

If the determination result of step S410 is positive, the current working channel wrkCH(a) is still good for the current medium environment, and option OPT4.1 will proceed. Thus, the APa device 31a and the STA2 device 33b continuously proceed with frame exchange procedures on the working channel wrkCH(a)=ch11 (step S411).

If the determination result of step S410 is negative, option OPT4.2 (step S413) is proceeded. The APa device 31a sends a request action (actFrm-REQ) frame to inform the STA2 device 33b that the current working channel wrkCH(a) needs to be changed to the optimized BSS channel obCH(APa+STA2) (step S413a). The optimized BSS channel obCH(APa+STA2 is then defined as the updated working channel wrkCH(a)′=obCH(APa+STA2)=ch1 in the connected mode (conMD).

The request action (actFrm-REQ) frame includes a channel switch announcement information element (CSA.IE). Optionally, the request action (actFrm-REQ) frame may include a quiet period information element (QUIET.IE). With the request action (actFrm-REQ) frame, the STA2 device 33b can hop to the optimized BSS channel obCH(APa+STA2)=ch11 in which the APa device 31a is hopping to, and the STA2 device 33b maintains its connection with the APa device 31a.

In response to the request action (actFrm-REQ) frame, the STA2 device 33b sends an acknowledgment frame (ACK) to the APa device 31a to confirm the use of the updated working channel wrkCH(a)′ (step S413c). After the APa device 31a and the STA2 device 33b both switch to the updated working channel wrkCH(a)′=ch1 (steps S413e, S413g), the APa device 31a and the STA2 device 33b proceed frame exchange procedures on the updated working channel wrkCH(a)′=obCH(APa+STA2)=ch1 (step S413)).

The steps in FIGS. 10A, 10B, 11A, and 11B are repetitively performed when the STA2 device 33b and the APa device 31a remain connected (in the connected mode conMD). In practical applications, the APa device 31a might connect to multiple STA devices and select the appropriate working channel wrkCH(a) for these associated STA devices. According to the embodiments of the present disclosure, the Wi-Fi system is suitable for small office or home environments with one AP device and 3˜5 STA devices.

Based on the embodiments above, the steps for collecting and utilizing the STA-side channel capability information CHinfo(STA) can be summarized in Table 9.

TABLE 9

| | | FIGS. 6A, 6B, 7A, 7B, | FIGS. 10A, 10B, 11A, |
|---|---|---|---|
| drawings | | and 7C | and 11C |
| in which mode STA | | connection | connected mode |
| collects STA-side channel | | establishment mode | (conMD) |
| capability information | | (estMD) | |
| CHinfo(STA) | | | |
| device | AP initiates | AP sends beacon | AP transmits |
| initiates | channel | (BCN) (with AP-side | query-ask frame of the |
| optimization | capability | optimized BSS channel | optimized BSS channel |
| | reporting | selection indicator | (obCH-Q-ASK) to STA |
| | mechanism, | (obcsIND-AP)) | (step S4031) |
| | and STA | | STA replies |
| | passively | | query-reply frame of the |
| | reacts | | optimized BSS channel |
| | | | (obCH-Q-RPLY) frame |
| | | | to STA (with or without |
| | | | optimized BSS channel |
| | | | request (obCH-REQ) |
| | | | frame |
| | STA actively | STA sends probe | STA directly sends |
| | initiates | request(probREQ) (with | optimized BSS channel |
| | channel | STA-side optimized BSS | request (obCH-REQ) |
| | capability | channel selection | frame (OPT3.1, step |
| | reporting | indicator | S401) |
| | mechanism | (obcsIND-STA)) | |
| | | AP sends probe | |
| | | response (probeRS) to | |
| | | STA (with AP-side | |
| | | optimized BSS channel | |
| | | selection indicator | |
| | | (obcsIND-AP)) | |

| approach that STA | STA sends association | OSTA sends STA-side |
|---|---|---|
| transmits STA-side | request (assREQ), in | channel capability |
| channel capability | which STA-side channel | information |
| information CHinfo(STA) | capability Information | CHinfo(STA) with |
| | CHinfo(STA) is carried | query-reply frame of the |
| | | optimized BSS channel |
| | | (obCH-Q-RPLY) frame |
| | | or optimized BSS |
| | | channel request |
| | | obCH-REQ |
| confirmation showing that | AP replies association | NA |
| CHinfo(STA) is received | response (assRSP) to | |
| | confirm that STA-side | |
| | channel capability | |
| | information CHinfo(STA) | |
| | has been received | |
| optimization procedure | AP performs multilateral quality factor analyses | |
| | based on AP-side channel capability information | |
| | CHinfo(AP) and STA-side channel capability | |
| | information CHinfo(STA) | |
| | step S215 in FIGS. 6B | step S409 in FIGS. 10A |
| | and 7B | and 11B |
| channel switch procedure | AP transmits request action (actFrm-REQ) to STA | |
| | STA transmits acknowledgment (ACK) to AP | |
| | AP and STA respectively, and parallelly perform | |
| | channel switch | |
| | OPT 2.2, step S219 in | OPT 4.2, step S413 in |
| | FIGS. 6B and 7C | FIGS. 10B and 11B |

FIGS. 12A˜12E are schematic diagrams illustrating a scenario in which the updated working channel wrkCH(a)′ corresponding to the BSSa is selected based on the AP-side channel capability information CHinfo(APa), the STA-side channel capability information CHinfo(STA2) collected from the STA2 device operating in the connected mode (conMD), and the STA-side channel capability information CHinfo(STA3) collected from the STA3 device operating in the connection establishment mode (estMD). In FIGS. 12A˜12E, it is assumed that STA2 device 33b transmits the STA-side channel capability information CHinfo(STA2) in the connected mode (conMD), and the STA3 device transmits the STA-side channel capability information CHinfo(STA3) in the connection establishment mode (estMD).

In short, the APa device 31a may receive the STA-side channel capability information CHinfo(STA) from STA devices operating in different modes. By cross-referring the AP-side channel capability information CHinfo(AP) and the STA-side channel capability information CHinfo(STA2), CHinfo(STA3), the APa device 31a selects the most appropriate Wi-Fi channel for the medium environment in a real-time manner.

In FIG. 12A, it is assumed that the APa device 31a and the STA2 device 33b are in the connected mode (conMD), and the STA3 device 33c is not yet connected to the APa device 31a. The APa device 31a and the STA2 device 33b may periodically/repetitively perform the channel allocation method as described in FIGS. 10˜11. That is, the STA2 device 33b updates the channel capability information CHinfo(STA2) to the APa device 31a from time to time in the connected mode (conMD).

In FIG. 12B, the STA3 device 33c enters the connection establishment mode (estMD). The APa device 31a and the STA3 device 33c perform the channel allocation method described in FIGS. 6 and 7. According to the illustrations in FIGS. 6 and 7, the STA3 device 33c transmits STA-side channel capability information CHinfo(STA3) to the APa device 31a in the connection establishment mode (estMD).

As the APa device 31a is already connected to the STA2 device 33b on Wi-Fi channel ch6. Wi-Fi channel ch6 is directly utilized as the default channel defCH(a)=ch6 between the APa device 31a and the STA3 device 33c in FIG. 12C. In FIG. 12C, the APa device 31a and the STA3 device 33c are in the connected mode (conMD), so as the APa deivce 31a and the STA2 device 33b.

In FIG. 12D, the APa device 31a considers and analyzes the AP-side channel capability information CHinfo(APa) and the STA-side channel capability information CHinfo(STA2), CHinfo(STA3) to select the optimized BSS channel obCH(APa+STA2+STA3). For the sake of illustration, it is assumed that the APa device 31a determines that Wi-Fi channel ch6 is still appropriate for both the STA2 device 33b and the STA3 device 33c. Therefore, the APa device 31a keeps on utilizing Wi-Fi channel ch6 as the working channel wrkCH(a)=ch6 in FIG. 12E. The communication efficiency and transmission quality between the APa device 31a and the STA2 device 33b can be improved, as can the total throughput.

In practical applications, the APa device 31a can employ an optimization selection algorithm to deal with the situations where the quality factors carried in the AP-side channel capability information CHinfo(APa) and STA-side channel capability information CHinfo(STA2), CHinfo(STA3) are not completely consistent. For such scenarios, Wi-Fi channel ch6 might not be selected as the optimized BSS channel obCH(APa+STA2+STA3) in FIG. 12D, and the working channel wrkCH(a) in FIG. 12E will be changed accordingly. Detailed descriptions are omitted as the actual Wi-Fi channel being selected as the optimized BSS channel obCH(APa+STA2+STA3) is varied with the real-time quality in the medium environment.

By continuously collecting the updated STA-side channel capability information CHinfo(STA2), CHinfo(STA3) from the STA2 and STA3 devices 33b, 33c, the APa device 31a can efficiently change the working channel wrkCH(a) channel to react to the changes of medium environment. With the updated channel capability information CHinfo(STA2) and CHinfo(STA3), the APa device 31a can select the updated working channel wrkCH(a) efficiently to react to the changes in the medium quality.

For the sake of illustration, it is assumed in FIGS. 12A˜12E that only the BSSa 30a exists in the medium environment. In practical applications, other BSS might also use the same Wi-Fi channel ch5 as its working channel wrkCH and cause interferences. For such situations, the STA-side channel capability information CHinfo(STA2), CHinfo(STA3) collected by the STA2 and STA3 devices 33b, 33c will change, and the optimized BSS channel obCH(APa+STA2+STA3) will vary. Details about such a scenario are omitted because implementing such situations can be conducted based on the illustrations above.

In the specification, the APa 31a device tries to find the least affected Wi-Fi channel (as the optimized BSS channel obCH) for communication. As the implementation of the channel allocation method may vary with the real-time medium status, the APa device 31a may periodically/repetitively query its associated STA devices in the connected mode (conMD). By doing so, the working channel wrkCH(a) can be dynamically changed to help the frame exchange procedures related to the APa device 31a to be performed on the most appropriate Wi-Fi channel. Please note that according to the embodiments, the channel allocation method not only improves the connection quality in the BSSa 30a but also improves the connection quality of the BSSb 30b because the potential conflict that occurred at the overlapped coverage area of the BSSa 30a and the BSSb 30b is eliminated.

By amending the frame control field in the MAC header, the channel allocation method can utilize different types of frames to carry/include the capability reporting frame (capRpFrm). The management type frames (type value=00) can be adopted in the channel allocation method, including but not limited to the association request (assREQ) frame (subtype value=0000), association response (assRSP) frame (subtype value=0001), probe request (probeREQ) frame (subtype value=0100), probe response (probeRS) frame (subtype value=0101), beacon (BCN) frame (subtype value=1000), and the action frame (subtype value=1101). The control type frames (type value=01) can be adopted in the channel allocation method, including but not limited to the acknowledgment (ACK) frame (subtype value=1101). The adoption and utilization of frame types in practical applications are not limited.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A Wi-Fi system, comprising:
a first Wi-Fi device, configured to collect first channel capability information corresponding to the first Wi-Fi device; and
a second Wi-Fi device, configured to collect and transmit second channel capability information corresponding to the second Wi-Fi device to the first Wi-Fi device,
wherein the first Wi-Fi device analyzes the first channel capability information and the second channel capability information in a connected mode to select an optimized channel accordingly.

2. The Wi-Fi system according to claim 1, wherein
the first Wi-Fi device selectively switches a working channel from a first Wi-Fi channel to a second Wi-Fi channel in the connected mode depending on whether the optimized channel is consistent with the working channel.

3. The Wi-Fi system according to claim 2, wherein
the first Wi-Fi device transmits a channel switch request to the second Wi-Fi device if the first Wi-Fi device determines to switch the working channel from the first Wi-Fi channel to the second Wi-Fi channel in the connected mode.

4. The Wi-Fi system according to claim 3, wherein
the second Wi-Fi device transmits an acknowledgment to the first Wi-Fi device in response to the channel switch request.

5. The Wi-Fi system according to claim 2, wherein
the first Wi-Fi device switches the working channel from the first Wi-Fi channel to the second Wi-Fi channel if the optimized channel is different from the working channel, and
the first Wi-Fi device remains using the first Wi-Fi channel as the working channel if the optimized channel is consistent with the working channel.

6. The Wi-Fi system according to claim 2, wherein
the second Wi-Fi device collects and transmits the second channel capability information in a connection establishment mode or in the connected mode,
wherein the first Wi-Fi device and the second Wi-Fi device enter the connected mode after the connection establishment mode is complete.

7. The Wi-Fi system according to claim 6, wherein before the second Wi-Fi device collects and transmits the second channel capability information in the connection establishment mode,
the first Wi-Fi device transmits a first channel selection indicator to the second Wi-Fi device, or
the first Wi-Fi device transmits the first channel selection indicator to the second Wi-Fi device to respond to a second channel selection indicator transmitted by the second Wi-Fi device.

8. The Wi-Fi system according to claim 6, wherein in the connected mode,
the second Wi-Fi device transmits a query-reply to the first Wi-Fi device in response to a query-ask transmitted by the first Wi-Fi device, wherein the query-reply selectively comprises the second channel capability information, or
the second Wi-Fi device transmits an optimization request comprising the second channel capability information to the first Wi-Fi device.

9. The Wi-Fi system according to claim 8, wherein
the second Wi-Fi device transmits another optimization request comprising the second channel capability information to the first Wi-Fi device if the query-reply excludes the second channel capability information.

10. The Wi-Fi system according to claim 1, wherein
the second channel capability information comprises a channel availability field representing N candidate Wi-Fi channels accessible for the second Wi-Fi device, wherein N is a positive integer greater than or equivalent to 2.

11. The Wi-Fi system according to claim 10, wherein
the second Wi-Fi device scans the N candidate Wi-Fi channels to collect the second channel capability information.

12. The Wi-Fi system according to claim 10, wherein
the optimized channel is one of the N candidate Wi-Fi channels.

13. The Wi-Fi system according to claim 10, wherein
the second channel capability information comprises a quality factor field, and the quality factor field comprises M bitwise quality indicators,
wherein the M bitwise quality indicators respectively correspond to M quality factors, and M is a positive integer.

14. The Wi-Fi system according to claim 13, wherein
P of the M bitwise quality indicators are set as enabled, and the P enabled bitwise quality indicators respectively correspond to P quality factors among the M quality factors,
wherein P is a positive integer, and P is smaller than or equivalent to M.

15. The Wi-Fi system according to claim 14, wherein
the second channel capability information represents P qualities of the N candidate Wi-Fi channels, and
the P quality factors indicate the P qualities of the N candidate Wi-Fi channels.

16. The Wi-Fi system according to claim 1, further comprising:
a third Wi-Fi device, configured to collect and transmit a third channel capability information to the first Wi-Fi device,
wherein the first Wi-Fi device analyzes the first channel capability information, the second channel capability information, and the third channel capability information to select the optimized channel accordingly.

17. The Wi-Fi system according to claim 16, wherein
the first Wi-Fi device and the second Wi-Fi device perform a plurality of first frame exchange procedures on the optimized channel, and
the first Wi-Fi device and the third Wi-Fi device perform a plurality of second frame exchange procedures on the optimized channel.

18. The Wi-Fi system according to claim 1, wherein
the first Wi-Fi device is an access point device, and
the second Wi-Fi device is a station device.

19. The Wi-Fi system according to claim 1, wherein
the first Wi-Fi device analyzes the first channel capability information and accordingly selects one of a plurality of candidate Wi-Fi channels as a default channel before the second Wi-Fi device becomes associated with the first Wi-Fi device, and
the second Wi-Fi device transmits the second channel capability information to the first Wi-Fi device on the default channel when the second Wi-Fi device is associated with the first Wi-Fi device.

20. A channel allocation method applied to a Wi-Fi system comprising a first Wi-Fi device and a second Wi-Fi device, wherein the channel allocation method comprises steps of:
the first Wi-Fi device collecting first channel capability information corresponding to the first Wi-Fi device;
the second Wi-Fi device collecting and transmitting second channel capability information corresponding to the second Wi-Fi device to the first Wi-Fi device; and
the first Wi-Fi device analyzing the first channel capability information and the second channel capability information in a connected mode to select an optimized channel accordingly.
